(19) United States
(12) Patent Application Publication
(10) Pub. No.: US 2022/0112323 A1
(43) Pub. Date: Apr. 14, 2022

(54) (METH)ACRYLATE-FUNCTIONALIZED BRANCHED POLYALPHA-OLEFINS

(71) Applicant: Arkema France, Colombes (FR)

(72) Inventors: Jeffrey KLANG, King of Prussia, PA (US); Jon SCHOLTE, King of Prussia, PA (US); Michael A. BAILEY, King of Prussia, PA (US); Thomas HAZELL, King of Prussia, PA (US)

(21) Appl. No.: 17/418,903

(22) PCT Filed: Dec. 17, 2019
(86) PCT No.: PCT/IB2019/001393

§ 371 Date: Jun. 28, 2021

Related U.S. Application Data
(60) Provisional application No. 62/786,575, filed on Dec. 31, 2018.

(51) Int. Cl. C08F 255/00; C08L 51/00; C09J 123/24; C09J 123/20; C09D 123/26; C09D 123/24

(52) U.S. Cl. CPC C08F 255/00; C08L 51/003; C09J 123/24; C08F 2810/30; C09D 123/26; C09D 123/24; C09J 123/20

(57) ABSTRACT

(Meth)acrylate-functionalized branched polyalpha-olefins which are the reaction product of, at least, a) a (meth)acrylate source and b) a hydroxyl-functionalized branched polymerizate of, at least, i) one or more alpha-olefin monomers having at least six carbon atoms per molecule and ii) one or more unsaturated hydroxyl-functionalized comonomers are useful hydrophobic, reactive components of crosslinkable resin compositions additionally containing a polymer (such as a polyolefin) as well as curable compositions containing one or more additional types of (meth)acrylate-functionalized compounds.

### FIELD OF THE INVENTION

The present invention relates to branched polyalpha-olefins that are functionalized with one or more (meth)acrylate groups per molecule as well as methods for making such (meth)acrylate-functionalized branched polyalpha-olefins. The reactivity of the (meth)acrylate functional groups permit the (meth)acrylate-functionalized branched polyalpha-olefins to be used as coagents for the crosslinking of thermoplastic polymers such as polyolefins and as components of radiation-curable resin compositions.

### BACKGROUND OF THE RELATED ART

Higher functionality (≥3 reactive functional groups per molecule) radiation-curable monomers and oligomers are widely used at present because of their ability to accelerate the cure rates of radiation-cured formulations and to provide desirable performance properties such as hardness, scratch and abrasion resistance, and chemical and stain resistance. Existing higher functionality materials are derived from raw materials such as pentaerythritol, dipentaerythritol, di-trimethylolpropane, hyperbranched polyester polyols, or alkoxylated derivatives thereof. Such products are relatively polar and hydrophilic. Higher functionality hydrophobic monomers and oligomers are desirable for uses where a high degree of moisture resistance, MVTR properties, or enhanced adhesion to low surface energy substrates is needed or where better compatibility with non-polar substances is required.

Accordingly, there remains a need for such higher functionality materials which are hydrophobic in character and yet can be readily reacted or cured, by radiation for example, to provide useful materials or articles having properties or attributes that cannot be obtained using more hydrophilic starting materials.

Alkyl (meth)acrylates in which the alkyl group is a long chain linear or branched alkyl group are known in the art, as evidenced by the following patent documents: U.S. Pat. No. 2,839,512; and U.S. Patent Application Publication No. 2012/0088707. Although they are hydrophobic, all of these substances bear just a single (meth)acrylate functional group per molecule. Accordingly, they are not capable of promoting a high degree of crosslinking in a cured product.

### SUMMARY OF THE INVENTION

(Meth)acrylate-functionalized branched polyalpha-olefins have now been developed which are derived from hydroxyl-functionalized branched polyalpha-olefins and which may have high (meth)acrylate functionality (three or more (meth)acrylate groups per molecule), yet are much less hydrophilic in character than conventional high functionality (meth)acrylates. The reactivity of the (meth)acrylate functional groups allows these substances to be readily incorporated into cured polymeric systems, with the non-polar branched polyalpha-olefin base structure favorably affecting the properties of such systems.

The present invention provides a (meth)acrylate-functionalized branched polyalpha-olefin comprising the reaction product of, at least, a) a (meth)acrylate source and b) a hydroxyl-functionalized branched polymerizate of, at least, i) one or more alpha-olefin monomers having at least six carbon atoms per molecule and ii) one or more unsaturated hydroxyl-functionalized comonomers, wherein one or more of the hydroxyl functional groups of the hydroxyl-functionalized branched polymerizate are converted to (meth)acrylate functional groups.

In other aspects, the invention provides a (meth)acrylate-functionalized branched polyalpha-olefin comprised of a plurality of repeating units A in accordance with Formula (III) and a plurality of repeating units B in accordance with Formula (IV):

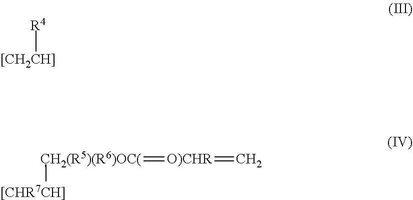

wherein R is H or methyl, R⁴ is an alkyl group comprised of at least four carbon atoms (preferably at least eight carbon atoms), R⁵ is a direct bond or a divalent alkylene group (e.g., a divalent C₁-C₂₀ alkylene group), R⁶ is optionally present, but if present, is a divalent oxyalkylene group or a divalent poly(oxyalkylene) group, and R⁷ is H or an alkyl group (e.g., a C₁-C₂₀ alkyl group, which may be linear or branched).

The present invention also provides a method of preparing a (meth)acrylate-functionalized branched polyalpha-olefin, comprising reacting a (meth)acrylate source and a hydroxyl-functionalized branched polymerizate of, at least, i) at least one alpha-olefin monomer having at least six carbon atoms per molecule and ii) at least one unsaturated hydroxyl-functionalized comonomer, wherein one or more of the hydroxyl functional groups of the hydroxyl-functionalized branched polymerizate are converted to (meth)acrylate functional groups.

A curable composition (such as an adhesive, sealant, coating, three dimensional printing and additive manufacturing resin, ink or molding resin) is provided in other aspects of the invention, wherein the curable composition is comprised of a (meth)acrylate-functionalized branched polyalpha-olefin in accordance with the invention and at least one (meth)acrylate-functionalized compound other than the (meth)acrylate-functionalized branched polyalpha-olefin. Articles may be prepared from the curable composition, using a method which comprises a step of exposing the curable composition to actinic radiation.

The invention additionally provides a crosslinkable resin composition comprised of a (meth)acrylate-functionalized branched polyalpha-olefin in accordance with the invention and at least one polymer (in particular a nonpolar polymer, such as a polyolefin). The crosslinkable resin composition may be crosslinked to form useful articles, wherein the (meth)acrylate-functionalized branched polyalpha-olefin may function as a co-agent.

### DETAILED DESCRIPTION OF THE INVENTION

### (Meth)Acrylate-Functionalized Branched Polyalpha-Olefins

The (meth)acrylate-functionalized branched polyalpha-olefins of the present invention are compounds which have a branched polymeric hydrocarbon structure which is substituted with one or more acrylate and/or methacrylate functional groups per molecule. The term “(meth)acrylate” as used herein refers to both acrylate and methacrylate. Similarly, the term “(meth)acrylic” includes both acrylic and methacrylic. The branched polymeric hydrocarbon portion imparts a highly hydrophobic character to the (meth)acrylate-functionalized branched polyalpha-olefin, while the (meth)acrylate functional group(s) provide one or more reactive sites in the compound that are capable of readily participating in polymerization or curing reactions through the carbon-carbon double bond of the (meth)acrylate functional group.

In certain embodiments of the invention, the (meth)acrylate-functionalized branched polyalpha-olefin or mixture of (meth)acrylate-functionalized branched polyalpha-olefins is liquid at 25° C. The viscosity of the (meth)acrylate-functionalized branched polyalpha-olefin or mixture of (meth)acrylate-functionalized branched polyalpha-olefins at 25° C. may, for example, be from about 350 to about 3000 cP, as measured using a Brookfield viscometer.

According to certain embodiments, a (meth)acrylate-functionalized branched polyalpha-olefin is provided which comprises the reaction product of at least a (meth)acrylate source and a hydroxyl-functionalized branched polymerizate of at least one alpha-olefin monomer having at least six (preferably at least ten) carbon atoms per molecule and at least one unsaturated hydroxyl-functionalized comonomer, wherein one or more (preferably two or more) of the hydroxyl functional groups of the hydroxyl-functionalized branched polymerizate are converted to (meth)acrylate functional groups. As will be described in more detail hereafter, the hydroxyl-functionalized branched polymerizate is obtained by copolymerization of at least one alpha-olefin monomer having at least ten carbon atoms per molecule, at least one unsaturated hydroxyl-functionalizing comonomer, and, optionally, at least one additional comonomer under conditions effective to promote branching, thereby providing the desired branched structure. The hydroxyl functional groups may be provided directly (in the case where the unsaturated hydroxyl-functionalizing comonomer bears one or more free hydroxyl functional groups) or indirectly (in the case where the polymerizate as produced has hydroxyl groups which are masked or protected, with the masking or protective groups being removed subsequent to polymerization).

The hydroxyl-functionalized branched polymerizate may have an average of at least one, but preferably at least two, at least three or at least four hydroxyl functional groups (—OH) per molecule.

The hydroxyl-functionalized branched polymerizate (and thus also the (meth)acrylate-functionalized branched polyalpha-olefin obtained therefrom) may be further characterized with respect to its polymer architecture in solution using triple detector size exclusion chromatography (SEC). Specifically, SEC coupled to multi-angle static light scattering (MALS), differential viscometry (VISC) and differential refractometry (DRI), can be used to determine absolute molar mass averages and distributions, polymeric size, the distribution of long-chain branches (LCBs) and the branching frequency. The SEC/MALS/VISC/DRI set-up can also provide the fractal dimensions of the polymer and the change in this dimension as a function of absolute molar mass. Each of the physical detectors listed measures a distinct polymeric radius that can be further combined to show whether a polymer is linear or branched. Additionally, combining viscometric data with molar mass data also yields information about branching via Mark-Houwink plots. The synergistic nature of the physical detectors coupled to the size-based separation allows for the determination of polymer architecture.

A plot commonly referred to as a conformation plot (i.e. the plot of log R_{G} versus Log M) is also obtainable by multi-detector SEC. Comparing the conformation plots of a branched species to that of a linear standard allows determination of g at each molar mass slide and from there, calculations of the number of branches as a continuous function of the molar mass of the branched macromolecule. An additional parameter that can be calculated using the branching number that can be determined is branching frequency, λ, (average number of branch points per 1000 units molecular weight). The root-mean-square radius, contraction factor, number of branching points and branching frequency can all be plotted as a function of molar mass, thus providing information about the LCB distribution within the hydroxyl-functionalized branched polymerizate.

Qualitative and semi quantitative description of the long-chain branching distribution can also be determined by multi-detector SEC, specifically SEC/VISC/DRI. The use of an online VISC allows for the determination of the ratio, g′, of the intrinsic viscosities or the branched molecule [η]_{B} and of the linear standard [η]_{L}, at the same molar mass M.

$${g}^{′} = {[ \frac{{( η )}_{B}}{{( η )}_{L}} ]}_{M}$$

The molar mass averages and the intrinsic viscosity measurements obtained by an SEC/MALS/VISC/DRI experiment can be used to determine if a polymer is linear or branched through a Mark-Houwink plot. A Mark-Houwink plot, is a log-log plot of the molar mass versus the intrinsic viscosity. The slope of a Mark-Houwink plot, a, corresponds with the molecular architecture of a polymer in solution. A polymer with a linear random coil architecture has a slope (a value) of 0.5-0.8, while a branched molecule has a slope from 0.33-0.5. The slope can change across the Mark-Houwink plot, i.e. as a function of molar mass, indicating the architecture of a polymer changes as a function of molar mass. The average molar mass between long-change branches in the hydroxyl-functionalized branched polymerizate and the meth)acrylate-functionalized branched polyalpha-olefin may be determined based on the molar mass of the point of intersection of the power laws describing the liner and branched regions of the Mark-Houwink plot, or of the conformation plot.

Suitable unsaturated hydroxyl-functionalized comonomers include organic compounds containing at least one site of ethylenic unsaturation (preferably only a single carbon-carbon double bond, which may be in a terminal or internal position). According to certain embodiments, the at least one unsaturated hydroxyl-functionalized comonomer includes at least one unsaturated hydroxyl-functionalized comonomer in accordance with Formula (I) or Formula (II):

HR¹C═CH—(R²)—CH₂OH (I)

HR¹C═CH—(R²)—CH₂—(OR³)ₘOH (II)

wherein m is an integer of 1 to 20 (preferably, 1 to 5), R¹ is H or a C₁-C₂₀ alkyl group (preferably H), R² is a direct bond or a divalent C₁-C₂₀ alkylene group (such as —CH₂—, —CH₂CH₂—, —CH₂CH(CH₃)—, etc.), and R³ is a divalent C₂-C₄ alkylene group (e.g., —CH₂CH₂— or —CH₂CH(CH₃)—). The C₁-C₂₀ alkylene group and the C₂-C₄ alkylene group may be linear or branched. In certain embodiments, the unsaturated hydroxyl-functionalized comonomer has a total number of carbon atoms within a range of from 3 to 25.

In still further embodiments, the at least one unsaturated hydroxyl-functionalized comonomer includes at least one unsaturated hydroxyl-functionalized comonomer in accordance with Formula (Ia) or Formula (IIb):

H₂C═CH(CH₂)ₙ—OH (Ia)

H₂C═CH(CH₂)ₙ—(OCH₂CHR)ₘOH (IIb)

wherein n is an integer of 1 to 24, m is an integer of 1 to 5, and R is —H or —CH₃.

Combinations of comonomers in accordance with Formula (I) and/or Formula (II) as well as combinations of comonomers in accordance with Formula (Ia) and/or Formula (IIb) may be used.

For example, the at least one unsaturated hydroxyl-functionalized comonomer may include at least one unsaturated hydroxyl-functionalized comonomer selected from the group consisting of allyl alcohol, 5-hexen-1-ol, 3-hexen-1-ol, 4-penten-1-ol, 3-penten-1-ol, 3-buten-1-ol, crotyl alcohol, elaidyl alcohol, gadoleyl alcohol, 9-decen-1-ol, 9-dodecen-1-ol, 10-undecylenyl alcohol, oleyl alcohol, erucyl alcohol, brassidyl alcohol, ethoxylated and/or propoxylated derivatives thereof, and combinations thereof. As used herein, the term “ethoxylated and/or propoxylated derivatives” refers to derivatives of the alcohols in which the hydroxyl functional group has been reacted with one or more equivalents of ethylene oxide, propylene oxide, or a combination of ethylene oxide and propylene oxide. To maintain a high degree of hydrophobicity in the (meth)acrylate-functionalized branched polyalpha-olefin, it will generally be desirable to limit the degree of alkoxylation of the unsaturated alcohol, e.g., fewer than 10 or fewer than 5 equivalents of epoxide per equivalent of hydroxyl.

The alpha-olefin monomer may correspond to the formula H₂C═CHR⁴ wherein R⁴ is an alkyl group containing at least four carbon atoms. The alkyl group may be linear or branched. Preferably, R⁴ is an alkyl group, in particular a linear alkyl group, containing at least eight carbon atoms. In various embodiments, R⁴ is an alkyl group containing no more than 48, no more than 43, or no more than 38 carbon atoms. Mixtures of such alpha-olefin monomers may be used.

The at least one alpha-olefin monomer having at least six (preferably at least 10) carbon atoms may, for example, be selected from the group consisting of 1-decene, 1-dodecene, 1-tetradecene, 1-hexadecene, 1-octadecene, 1-eicosene, and combinations thereof. For example, the alpha-olefin monomer having at least 10 carbon atoms may be a mixture of alpha-olefin monomers having chain lengths selected from the group consisting of C₁₀-C₁₃, C₂₀-C₂₄, C₂₄-C₂₈, and C₃₀ and higher chain lengths.

The number average molecular weight of the (meth)acrylate-functionalized branched polyalpha-olefin is not believed to be particularly limited and may be varied as may be desired in order to tailor the properties and characteristics of the (meth)acrylate-functionalized branched polyalpha-olefin and products obtained therefrom. In various embodiments of the invention, the (meth)acrylate-functionalized branched polyalpha-olefin may have a number average molecular weight of at least 500, at least 750, or at least 1000 daltons. In other embodiments, the (meth)acrylate-functionalized branched polyalpha-olefin may have a number average molecular weight of not more than 10,000, not more than 5000, or not more than 3000 daltons. For example, the (meth)acrylate-functionalized branched polyalpha-olefin may have a number average molecular weight of from 500 to 10,000 daltons or from 750 to 5000 daltons.

The (meth)acrylate source may be any compound or combination of compounds that is capable of reacting with the hydroxyl group(s) of the hydroxyl-functionalized branched polymerizate to provide the (meth)acrylate-functionalized branched polyalpha-olefin. Such a reaction may be considered an esterification reaction, wherein a hydroxyl group is converted to an ester ((meth)acrylate) group. As will be described in more detail subsequently, the (meth)acrylate source may be selected from the group consisting of (meth)acrylic acid, (meth)acrylic anhydride, (meth)acryloyl halides (such as (meth)acrylic chloride), and C₁-C₄ esters of (meth)acrylic acid.

The (meth)acrylate-functionalized branched polyalpha-olefin may contain 1, 2, 3, 4, 5 or more, preferably 2 or more, (meth)acrylate functional groups per molecule. For example, from 1 to 8 or 2 to 6 (meth)acrylate functional groups per molecule may be present in the (meth)acrylate-functionalized branched polyolefin. Some or all of the hydroxyl functional groups of the hydroxyl-functionalized branched polymerizate may be converted to (meth)acrylate functional groups. For example, in one embodiment the (meth)acrylate-functionalized branched polyalpha-olefin may comprise one or more hydroxyl groups and one or more (meth)acrylate groups per molecule. In other embodiments, the (meth)acrylate-functionalized branched polyalpha-olefin may comprise one or more (preferably, two or more) (meth)acrylate groups per molecule, but no hydroxyl group. According to still further embodiments, at least 20%, at least 30%, at least 40%, at least 50%, at least 60%, at least 70%, at least 80%, at least 90% or at least 95% of the hydroxyl functional groups of the hydroxyl-functionalized branched polymerizate are converted to (meth)acrylate functional groups.

Also contemplated by the present invention are compositions comprising a mixture of two or more different (meth)acrylate-functionalized branched polyolefins in accordance with the foregoing description.

Further embodiments of the present invention provide a (meth)acrylate-functionalized branched polyalpha-olefin comprised of, consisting essentially of or consisting of a plurality of repeating units A in accordance with Formula (III) and a plurality of repeating units B in accordance with Formula (IV):

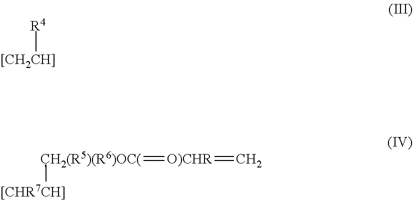

wherein R is H or methyl, R⁴ is an alkyl group comprised of at least four carbon atoms (preferably at least eight carbon atoms), R⁵ is a direct bond or a divalent alkylene group (e.g., a divalent C₁-C₂₀ alkylene group, which may be linear or branched), R⁶ is optionally present, but if present, is a divalent oxyalkylene group or a divalent poly(oxyalkylene) group, and R⁷ is H or an alkyl group (e.g., a C₁-C₂₀ alkyl group, which may be linear or branched).

Other embodiments of the present invention provide a (meth)acrylate-functionalized branched polyalpha-olefin comprised of, consisting essentially of or consisting of a plurality of repeating units A in accordance with Formula (Ma) and a plurality of repeating units B in accordance with Formula (IVb):

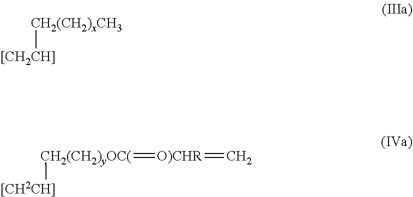

wherein x is an integer of at least 6, y is an integer of at least 0 (e.g., 0 to 28), and R is H or methyl.

The (meth)acrylate-functionalized branched polyalpha-olefin may be additionally comprised of one or more types of repeating units other than repeating units A and B. For example, such additional repeating units may correspond to Formula (V):

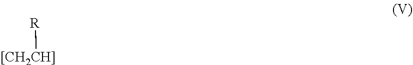

wherein R is H or a C₁-C₃ alkyl group (e.g., methyl, ethyl, propyl).

Repeating units additionally present in the (meth)acrylate-functionalized branched polyalpha-olefin could also correspond to Formula (VI):

[CH₂CR′R″] (VI)

wherein R′ and R″ are the same or different and are each an alkyl group (e.g., a C₁-C₂₀ alkyl group, which may be linear or branched).

As another example, the (meth)acrylate-functionalized branched polyalpha-olefin may be additionally comprised of one or more repeating units in accordance with Formula (VII):

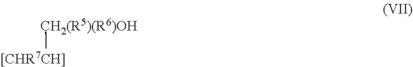

wherein R⁵ is a direct bond or a divalent alkylene group (e.g., a divalent C₁-C₂₀ alkylene group, which may be linear or branched), R⁶ is optionally present, but if present, is a divalent oxyalkylene group or a divalent poly(oxyalkylene) group, and R⁷ is H or an alkyl group (e.g., a C₁-C₂₀ alkyl group, which may be linear or branched);
or in accordance with Formula (VIIa):

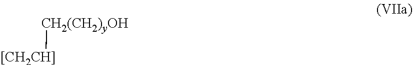

wherein y is an integer of at least 0 (e.g., 0 to 28).

It is also possible for the (meth)acrylate-functionalized branched polyalpha-olefin to be additionally comprised of one or more repeating units in accordance with Formula (VII) or Formula (VIIa) wherein the —OH group is replaced by —OC(═O)Y, wherein Y is H or a saturated alkyl group such as a methyl group. However, in certain embodiments the content of repeating units other than repeating unit A and repeating unit B in the (meth)acrylate-functionalized branched polyalpha-olefin is limited. For example, at least 50%, at least 60%, at least 70%, at least 80%, or at least 90% of the total repeating units in the (meth)acrylate-functionalized branched polyalpha-olefin may correspond to Formula (III) and Formula (IV).

According to certain embodiments, the (meth)acrylate-functionalized branched polyalpha-olefin has a low content of repeating units containing heteroatoms other than repeating units corresponding to Formula (IV) or Formula (VII).

According to certain embodiments, the above-described repeating units are arranged randomly or statistically along the backbone and branches of the (meth)acrylate-functionalized branched polyalpha-olefin. However, in other embodiments, the (meth)acrylate-functionalized branched polyalpha-olefin may have a more ordered structure.

### Methods of Making (Meth)Acrylate-Functionalized Branched Polyalpha-Olefins

As mentioned in the above discussion, the (meth)acrylate-functionalized branched polyalpha-olefins may be prepared by esterifying a hydroxyl-functionalized branched polymerizate with a suitable (meth)acrylate source. Such esterification introduces the desired (meth)acrylate functional groups onto the branched polyalpha-olefin.

The hydroxyl-functionalized branched polymerizate may be prepared using any method known in the art such as, for example, the procedures described in U.S. Pat. No. 7,314,904, which is incorporated herein by reference in its entirety for all purposes. The polymerization procedures described in U.S. Pat. No. 4,060,569, the disclosure of which is incorporated herein by reference in its entirety for all purposes, may also be suitably adapted for use in preparing the hydroxyl-functionalized branched polymerizate. Suitable hydroxyl-functionalized branched polymerizates are also available from commercial sources, such as the hydroxyl-functionalized branched polymerizates sold under the brand name “Vybar” by Baker Hughes Incorporation.

Suitable hydroxyl-functionalized branched polymerizates include the reaction mixtures obtained by subjecting an admixture comprising at least (a) at least one alpha-olefin monomer having at least six (preferably, at least 10) carbon atoms; (b) at least one hydroxyl-functionalizing unsaturated monomer; and (c) at least one polymerization initiator to reaction conditions sufficient to copolymerize the alpha-olefin monomer(s) and hydroxyl-functionalizing unsaturated monomer(s). The admixture may optionally additionally comprise one or more additional types of reactive comonomers, such as alpha-olefin monomers having fewer than six carbon atoms, vinylidene compounds, and/or internal olefins and/or one or more additional polymerization components such as solvents, chain transfer agents, promoters/accelerators for the polymerization initiator(s), and the like. According to various embodiments of the invention, at least 50%, at least 60%, at least 70%, at least 80%, at least 90% or at least 95% by weight of the monomers present in the admixture are alpha-olefin monomers having six or more carbon atoms per molecule and hydroxyl-functionalizing unsaturated monomers.

Alpha-olefins useful in the present invention are ethylenically unsaturated organic compounds containing six carbon atoms or more (more preferably eight carbon atoms or more, most preferably ten carbon atoms or more) in which a carbon-carbon double bond appears at a terminal position of the compound, as represented by the generic structure H₂C═CH—R wherein R is a hydrocarbon group, preferably an aliphatic hydrocarbon group, most preferably a saturated aliphatic hydrocarbon group. R may be a straight chain or branched alkyl group, for example. The maximum number of carbon atoms in the alpha-olefin is not particularly limited and consequently may be, for example, as many as 50, 45, 40, or 35. According to various embodiments of the invention, one or more C₆-C₅₀ alpha-olefins, one or more C₈-C₄₅ alpha-olefins or one or more C₁₀ to C₄₀ alpha-olefins may be utilized. Preferred alpha-olefins are mono-ethylenically unsaturated organic compounds. Alpha-olefins that may be used to prepare the hydroxyl-functionalized branched polymerizate include, but are not limited to, 1-decene, 1-dodecene, 1-tetradecene, 1-hexadecene, 1-octadecene, 1-eicosene, as well as such commercial mixtures sold as alpha-olefins including those having mainly C₁₀-C₁₃, C₂₀-C₂₄ chain lengths, C₂₄-C₂₈ chain lengths and C₃₀ and higher chain lengths. The alpha-olefin(s) may have structures corresponding to Formula (IX):

H₂C═CHCH₂(CH₂)ₓCH₃ (IX)

wherein x is an integer of at least two, more preferably at least four, still more preferably at least six.

The unsaturated hydroxyl-functionalizing compounds useful in preparing the hydroxyl-functionalized branched polymerizates include, but are not limited to, unsaturated alcohols, alkoxylated unsaturated alcohols and esters of such unsaturated alcohols and alkoxylated unsaturated alcohols (in particular, acetic acid and formic acid esters of the unsaturated alcohols and alkoxylated unsaturated alcohols). Typically, such unsaturated hydroxyl-functionalizing compounds will have a single site of ethylenic unsaturation (i.e., a monoethylenically unsaturated hydroxyl-functionalizing compound), which may be in an alpha position (i.e., the compound may be an alpha, beta-unsaturated alcohol) or which may be internal. According to certain embodiments, the unsaturated hydroxyl-functionalizing compound is aliphatic. According to other embodiments, the unsaturated hydroxyl-functionalizing compound contains a single hydroxyl group (or precursor thereof, such as an ester group capable of being converted to a hydroxyl group) per molecule, although in other embodiments two or more hydroxyl groups (or precursors thereof) may be present in an unsaturated hydroxyl-functionalizing compound. Preferably, the hydroxyl functional group is a primary or secondary hydroxyl functional group; most preferably, the hydroxyl functional group is a primary hydroxyl functional group. If an ester of an unsaturated alcohol is utilized as an unsaturated hydroxyl-functionalizing compound, it is similarly preferred that when the ester group is converted to a hydroxyl group, the resulting hydroxyl group is secondary or, more preferably, primary. The unsaturated hydroxyl-functionalizing compound may be a short chain compound (fewer than 6 carbon atoms) or a long chain compound (6 or more carbon atoms). As used herein, the term “hydroxyl-functionalizing compound” encompasses both compounds that contain a free hydroxyl group (as in allyl alcohol, for example) as well as compounds that contain a masked or protected hydroxyl group (as in allyl acetate, for example).

Useful hydroxyl-functionalizing compounds include unsaturated alcohols such as allyl alcohol, 5-hexen-1-ol, 3-hexen-1-ol, 4-penten-1-ol, 3-penten-1-ol, 3-buten-1-ol, crotyl alcohol, elaidyl alcohol (9-trans-octadecen-1-ol), gadoleyl alcohol (9-cis-eicosen-1-ol), 9-decen-1-ol, 9-dodecen-1-ol, 10-undecylenyl alcohol, oleyl alcohol (9-cis-octadecen-1-ol), erucyl alcohol (13-cis-docosen-1-ol), brassidyl alcohol (13-trans-docosen-1-ol), ethoxylated and/or propoxylated derivatives thereof, and acetic acid and formic acid esters of these alcohols.

For example, one or more hydroxyl-functionalizing compounds in accordance with Formula (VIII) may be employed:

H₂C═CHCH₂(CH₂)_{y}OH (VIII)

wherein y is an integer of at least 0.

One or more hydroxyl-functionalizing compounds in accordance with Formula (VIIIa) could also be used:

H₂C═CHCH₂(CH₂)_{y}OC(═O)Y (VIIIa)

wherein y is an integer of at least 0 and Y is H or alkyl (e.g., C₁-C₆ alkyl, such as methyl).

The hydroxyl-functionalizing compound(s) may incorporated into the backbone or side chains of the branched polymerizate being produced. The molar ratio of alpha olefin monomer(s) to hydroxyl-functionalizing unsaturated monomer(s) may be, in various embodiments, from about 20:1 to 1:20, from about 10:1 to 1:10, or from about 8:1 to 1:2.

A polymerization initiator or combination of polymerization initiators may be used to prepare the hydroxyl-functionalized branched polymerizate. Preferably, this polymerization initiator is a free radical initiator. For example, the polymerization initiator may be an organic peroxide or combination of organic peroxides. Organic peroxides that may be used include, but are not limited to, dialkyl peroxides, diacyl peroxides, peroxyesters, peroxycarbonates, alkylaryl peroxides, alkyl hydroperoxides, and aralkyl hydroperoxides, such as dibenzoyl peroxide, tert-amylperoxy 2-ethylhexanoate, tert butylperoxy 2-ethylhexanoate, tert-butylperoxy isobutyrate, and tert-butylperoxy isopropyl carbonate, tert-butylperoxy 3,5,5-trimethylhexanoate, 2,5-dimethyl-2,5-di(benzoyl peroxy)hexane, tert-butylperoxy acetate, tert-butylperoxy benzoate, n-butyl4,4-di(tert-butylperoxy)valerate, dicumyl peroxide, tert-butylcumyl peroxide, di(2-tert-butylperoxy isopropyl)benzene, 2,5-dimethyl-2,5-di(tert-butyl peroxy)hexane, di(tert-butyl)peroxide, 2,5-dimethyl-2,5-di(tert-butyl peroxy)-3-hexyne, tert-butyl hydroperoxide, cumyl hydroperoxide, and mixtures thereof.

Other types of free radical initiators, such as azo compounds, can also be used. Azo compounds useful as free radical initiators include, but are not limited to, 2,2′-azobisisopropionitrile, 2,2′-azobisisobutyronitrile (AIBN), dimethyl azoisobutyrate, 1,1′azobis(cyclohexanecarbonitrile), 20 2,2′-azobis(2-methylpropane), and mixtures thereof.

Promoters, accelerators, and/or chain transfer agents may be used in combination with the free radical initiator(s).

Hydroxyl functionality may also be introduced into the polymerizate by carrying out a copolymerization using an alpha-olefin (or mixture of alpha-olefins) and one or more co-monomers containing a masked or protected hydroxyl functional group, then removing the masking or protecting group to generate the desired hydroxyl group. For example, the masking or protective group may be an ester group, such as an acetate or formate group. Once the polymerizate has been formed, free hydroxyl groups can be generated by de-esterification (e.g., deacetylation or deformylation). Suitable deprotection methods for this purpose, such as base-catalyzed hydrolysis, are known in the art.

An admixture comprising one or more alpha-olefin monomers having at least six (preferably at least ten) carbon atoms; one or more unsaturated hydroxyl-functionalizing compounds; and at least one polymerization initiator is reacted under conditions sufficient to polymerize the alpha-olefin monomer(s) and unsaturated hydroxyl-functionalizing compound(s). Other components, including other types of monomers, may optionally be present in the admixture, as previously described. Alternatively, the polymerization initiator may be added in increments to the reactants (alpha-olefin monomer(s), unsaturated hydroxyl-functionalizing compound(s), and optionally other co-monomers) over the course of the reaction, or one of the reactants may be added, in whole or in part, incrementally along with the initiator. The molar ratio of polymerization initiator (e.g., free radical initiator) to reactants may be, for example, from about 0.005 to 0.35. Where a free radical initiator such as an organic peroxide is used, reaction (polymerization) times of from about 1 to about 20 times the half-life of the free radical initiator at the reaction temperature generally will be suitable. The polymerization may be carried out at low pressures, e.g., less than about 500 psig. According to certain embodiments, the pressure during polymerization is sufficient to substantially prevent vaporization of the reactants. The polymerization temperature may be set such that the free radical initiator has a half-life of from about 0.5 to about 3 hours. This in turn is a function of the temperature at which the free radical initiator decomposes. Suitable polymerization temperatures may be, for example, within the range of from about 40° C. to about 250° C. In one embodiment, the reactants and polymerization initiator are combined in a reactor and, under an inert gas pad, allowed to react at a temperature of 80° C. to 180° C.

After the polymerization (and removal of hydroxyl-protective groups, if any), the hydroxyl-functionalized branched polymerizate may have a number average molecular weight, determined using gel permeation chromatography procedure and polystyrene standards, of from about 200 daltons to about 10,000 daltons, or from about 400 daltons to about 5,000 daltons, or from about 600 daltons to about 3,000 daltons, in various embodiments of the invention.

The hydroxyl equivalent weight of the hydroxyl-functionalized branched polymerizate may be varied as may be desired, depending upon the properties and characteristics sought in the (meth)acrylate-functionalized branched polyalpha-olefin prepared therefrom. For example, the hydroxyl-functionalized branched polymerizate may have a hydroxyl equivalent weight of from 200 to 2000 or from 300 to 1000 g per equivalent of hydroxyl, according to certain exemplary embodiments of the invention.

As previously mentioned, the (meth)acrylate-functionalized branched polyalpha-olefins of the present invention may be obtained by reacting the hydroxyl-functionalized branched polymerizate with a (meth)acrylate source under conditions effective to transform one or more of the hydroxyl groups present in the hydroxyl-functionalized branched polymerizate into (meth)acrylate functional groups. This transformation is illustrated below for the case where the (meth)acrylate source is acrylic acid (wherein R is the remainder of the hydroxyl-functionalized branched polymerizate):

R—OH+HOC(═O)CH═CH₂→R—O—C(═O)CH═CH₂+H₂O

The reaction conditions effective for this purpose will vary depending upon a number of factors, including for example the reactivity of the hydroxyl functional groups on the hydroxyl-functionalized branched polymerizate and the reactivity of the (meth)acrylate source. Suitable (meth)acrylate sources include, in addition to (meth)acrylic acid, (meth)acrylic anhydride, (meth)acryloyl halides, and (meth)acrylate esters (especially C₁-C₄ alkyl esters of (meth)acrylic acid). The reaction of the (meth)acrylate source with the hydroxyl-functionalized branched polymerizate may take place by way of an esterification reaction, a transesterification reaction or an interesterification reaction, for example. Reactions involving (meth)acrylate sources and other hydroxyl functional group-containing substances are well known in the art, and any of the procedures, reaction conditions, catalysts, and polymerization inhibitors used for such reactions may be readily adapted for use in the present invention. The stoichiometry between the (meth)acrylate source and the hydroxyl-functionalized branched polymerizate may be adjusted as may be appropriate in order to achieve the desired degree of conversion of the hydroxyl groups in the hydroxyl-functionalized branched polymerizate to (meth)acrylate functional groups. For example, the amounts of (meth)acrylate source and hydroxyl-functionalized branched polymerizate which are reacted may be selected so as to provide a molar ratio of (meth)acrylate source:hydroxyl functional groups may be from 0.1:1 to 1.1:1. A molar excess of the (meth)acrylate source may be employed if it is desired to achieve essentially complete esterification of the hydroxyl-functionalized branched polymerizate.

One or more promoters or catalysts may be used to accelerate the rate at which the (meth)acrylate source reacts with the hydroxyl-functionalized branched polymerizate. Any of such promoters and catalysts known in the art may be utilized, including for example acids (e.g., phosphorus-based acids such as hypophosphorous acid, sulfur-based acids such as sulfonic acids), bases, metallic compounds (e.g., zirconium acetylacetonate) and the like.

To the extent the reaction of the (meth)acrylate source with the hydroxyl-functionalized branched polymerizate produces a co-product, it may be helpful to remove the co-product from the reaction mixture in order to drive the reaction to completion, especially if a high degree of (meth)acrylation is desired. For example, where the (meth)acrylate source is (meth)acrylic acid, the water generated as a co-product may be removed by any suitable method such as sparging, distillation (including azeotropic distillation using an azeotrope), vacuum stripping or the like. Similarly, where the (meth)acrylate source is a C₁-C₄ alkyl ester of (meth)acrylic acid, the C₁-C₄ aliphatic alcohol formed as a co-product may be removed using similar techniques.

The presence of one or more polymerization inhibitors in the reaction mixture as the (meth)acrylate source and the hydroxyl-functionalized branched polymerizate may be desirable in order to prevent or reduce the undesired reaction of the (meth)acrylate functional groups. Suitable polymerization inhibitors include, for example, phenolic compounds (especially hindered phenolic compounds), thioazines, hydroquinones, amines and the like and combinations thereof.

The reaction product thereby obtained may be subjected to any further processing or purification step or steps in order to obtain the final (meth)acrylate-functionalized branched polyalpha-olefin. Suitable techniques may include, for example, neutralization, washing, removal of catalysts used for the esterification, stripping (to remove volatiles), and the like.

One or more stabilizers may be added to the (meth)acrylate-functionalized branched polyalpha-olefin thereby obtained.

For example, in one embodiment of the invention a mixture of (meth)acrylic acid, a hydroxyl-functionalized branched polymerizate, acidic catalyst, polymerization inhibitor and a solvent capable of forming an azeotrope with water is heated to a temperature effective to cause reaction between the (meth)acrylic acid and the hydroxyl-functionalized branched polymerizate, whereby esterification of the hydroxyl groups of the hydroxyl-functionalized branched polymerizate takes place, generating water as a co-product which is removed from the mixture by azeotropic distillation with the solvent. Once the desired degree of esterification has been achieved (as assessed by the quantity of water co-product generated), the acidic catalyst may be neutralized and the reaction product containing the desired (meth)acrylate-functionalized branched polyalpha-olefin washed with water and then stripped of solvent and other volatiles under vacuum to yield the (meth)acrylate-functionalized branched polyalpha-olefin.

### Uses for (Meth)Acrylate-Functionalized Branched Polyalpha-Olefins

(Meth)acrylate-functionalized branched polyalpha-olefins in accordance with the present invention are useful in a wide variety of applications. For example, they may be used in coatings, inks, adhesives, sealants and three-dimensional parts (e.g., molded parts, parts produced by additive manufacturing), especially where moisture resistance combined with a high degree of crosslinking is needed. As another example, the inventive (meth)acrylate-functionalized branched polyalpha-olefins may be employed as co-agents in the crosslinking of of thermoplastic polymers, particularly hydrophobic polymers such as polyolefins. They generally exhibit a high degree of compatibility with other non-polar, hydrophobic materials such as high molecular weight polyethylenes and polypropylenes and can also improve adhesion to surfaces having low surface energies.

### Curable Compositions

As previously mentioned, the (meth)acrylate-functionalized branched polyalpha-olefins of the present invention are particularly useful in the formulation of curable compositions additionally comprising one or more other types of (meth)acrylate-functionalized compounds. Such other (meth)acrylate-functionalized compounds suitably include any organic compounds containing one or more acrylate and/or methacrylate functional groups per molecule, wherein such (meth)acrylate functional group(s) is or are capable of reacting together with the (meth)acrylate functional groups of the (meth)acrylate-functionalized branched polyalpha-olefin to provide a cured, polymeric matrix.

The relative amounts of (meth)acrylate-functionalized branched polyalpha-olefin(s) in accordance with the present invention and other (meth)acrylate-functionalized compound(s) is not considered to be critical and may be varied widely, depending upon the particular components selected for use and the properties sought in the curable composition and the cured composition obtained therefrom. For example, the curable composition may be comprised of 0.5 to 99.5% by weight (meth)acrylate-functionalized branched polyalpha-olefin and 0.5 to 99.5% by weight (meth)acrylate-functionalized compound other than (meth)acrylate-functionalized branched polyalpha-olefin, based on the total weight of (meth)acrylate-functionalized branched polyalpha-olefin and (meth)acrylate-functionalized compound other than (meth)acrylate-functionalized branched polyalpha-olefin.

Suitable (meth)acrylate-functionalized compounds include both (meth)acrylate-functionalized monomers and (meth)acrylate-functionalized oligomers.

According to certain embodiments of the invention, the curable composition comprises, in addition to at least one (meth)acrylate-functionalized branched polyalpha-olefin in accordance with the invention, at least one (meth)acrylate-functionalized monomer containing two or more (meth)acrylate functional groups per molecule. Examples of useful (meth)acrylate-functionalized monomers containing two or more (meth)acrylate functional groups per molecule include acrylate and methacrylate esters of polyhydric alcohols (organic compounds containing two or more, e.g., 2 to 6, hydroxyl groups per molecule). Specific examples of suitable polyhydric alcohols include C₂₋₂₀ alkylene glycols (glycols having a C₂₋₁₀ alkylene group may be preferred, in which the carbon chain may be branched; e.g., ethylene glycol, trimethylene glycol, 1,2-propylene glycol, 1,2-butanediol, 1,3-butanediol, 2,3-butanediol, tetramethylene glycol (1,4-butanediol), 1,5-pentanediol, 1,6-hexanediol, 1,8-octanediol, 1,9-nonanediol, 1,12-dodecanediol, cyclohexane-1,4-dimethanol, bisphenols, and hydrogenated bisphenols, as well as alkoxylated (e.g., ethoxylated and/or propoxylated) derivatives thereof, wherein for example from 1 to 20 moles of an alkylene oxide such as ethylene oxide and/or propylene oxide has been reacted with 1 mole of glycol), diethylene glycol, glycerin, alkoxylated glycerin, triethylene glycol, dipropylene glycol, tripropylene glycol, trimethylolpropane, alkoxylated trimethylolpropane, ditrimethylolpropane, alkoxylated ditrimethylolpropane, pentaerythritol, alkoxylated pentaerythritol, dipentaerythritol, alkoxylated dipentaerythritol, cyclohexanediol, alkoxylated cyclohexanediol, cyclohexanedimethanol, alkoxylated cyclohexanedimethanol, norbornene dimethanol, alkoxylated norbornene dimethanol, norbornane dimethanol, alkoxylated norbornane dimethanol, polyols containing an aromatic ring, cyclohexane-1,4-dimethanol ethylene oxide adducts, bis-phenol ethylene oxide adducts, hydrogenated bisphenol ethylene oxide adducts, bisphenol propylene oxide adducts, hydrogenated bisphenol propylene oxide adducts, cyclohexane-1,4-dimethanol propylene oxide adducts, sugar alcohols and alkoxylated sugar alcohols. Such polyhydric alcohols may be fully or partially esterified (with (meth)acrylic acid, (meth)acrylic anhydride, (meth)acryloyl chloride or the like), provided they contain at least two (meth)acrylate functional groups per molecule. As used herein, the term “alkoxylated” refers to compounds in which one or more epoxides such as ethylene oxide and/or propylene oxide have been reacted with active hydrogen-containing groups (e.g., hydroxyl groups) of a base compound, such as a polyhydric alcohol, to form one or more oxyalkylene moieties. For example, from 1 to 25 moles of epoxide may be reacted per mole of base compound. According to certain aspects of the invention, the (meth)acrylate-functionalized monomer(s) used may be relatively low in molecular weight (e.g., 100 to 1000 daltons).

Any of the (meth)acrylate-functionalized oligomers known in the art may also be used in the present invention. According to certain embodiments, such oligomers contain two or more (meth)acrylate functional groups per molecule. The number average molecular weight of such oligomers may vary widely, e.g., from about 500 to about 50,000. According to certain embodiments, as the number average molecular weight of the oligomer is increased, it may be preferred to increase the average functionality of the oligomer (i.e., to increase the average number of (meth)acrylate functional groups per molecule of the oligomer) to 3, 4 or higher.

Suitable (meth)acrylate-functionalized oligomers include, for example, polyester (meth)acrylate oligomers, epoxy (meth)acrylate oligomers, polyether (meth)acrylate oligomers, polyurethane (meth)acrylate oligomers, acrylic (meth)acrylate oligomers, polydiene (meth)acrylate oligomers, polycarbonate (meth)acrylate oligomers and combinations thereof. Such oligomers may be selected and used in combination with one or more (meth)acrylate-functionalized monomers in order to enhance the flexibility, strength and/or modulus, among other attributes, of a cured resin foam prepared using the multi-component system of the present invention.

Exemplary polyester (meth)acrylate oligomers include the reaction products of acrylic or methacrylic acid or mixtures thereof with hydroxyl group-terminated polyester polyols. The reaction process may be conducted such that all or essentially all of the hydroxyl groups of the polyester polyol have been (meth)acrylated, particularly in cases where the polyester polyol is difunctional. The polyester polyols can be made by polycondensation reactions of polyhydroxyl functional components (in particular, diols) and polycarboxylic acid functional compounds (in particular, dicarboxylic acids and anhydrides). The polyhydroxyl functional and polycarboxylic acid functional components can each have linear, branched, cycloaliphatic or aromatic structures and can be used individually or as mixtures.

Examples of suitable epoxy (meth)acrylate oligomers include the reaction products of acrylic or methacrylic acid or mixtures thereof with glycidyl ethers or esters.

Suitable polyether (meth)acrylate oligomers include, but are not limited to, the condensation reaction products of acrylic or methacrylic acid or mixtures thereof with polyetherols which are polyether polyols (such as polyethylene glycol, polypropylene glycol or polytetramethylene glycol). Suitable polyetherols can be linear or branched substances containing ether bonds and terminal hydroxyl groups. Polyetherols can be prepared by ring opening polymerization of cyclic ethers such as tetrahydrofuran or alkylene oxides with a starter molecule. Suitable starter molecules include water, polyhydroxyl functional materials, polyester polyols and amines.

Polyurethane (meth)acrylate oligomers (sometimes also referred to as “urethane (meth)acrylate oligomers”) capable of being used in the multi-component systems of the present invention include urethanes based on aliphatic and/or aromatic polyester polyols and polyether polyols and aliphatic and/or aromatic polyester diisocyanates and polyether diisocyanates capped with (meth)acrylate end-groups. Suitable polyurethane (meth)acrylate oligomers include, for example, aliphatic polyester-based urethane di- and tetra-acrylate oligomers, aliphatic polyether-based urethane di- and tetra-acrylate oligomers, as well as aliphatic polyester/polyether-based urethane di- and tetra-acrylate oligomers.

In various embodiments, the polyurethane (meth)acrylate oligomers may be prepared by reacting aliphatic and/or aromatic diisocyanates with OH group terminated polyester polyols (including aromatic, aliphatic and mixed aliphatic/aromatic polyester polyols), polyether polyols, polycarbonate polyols, polycaprolactone polyols, polydimethysiloxane polyols, or polybutadiene polyols, or combinations thereof to form isocyanate-functionalized oligomers which are then reacted with hydroxyl-functionalized (meth)acrylates such as hydroxyethyl acrylate or hydroxyethyl methacrylate to provide terminal (meth)acrylate groups. For example, the polyurethane (meth)acrylate oligomers may contain two, three, four or more (meth)acrylate functional groups per molecule.

Suitable acrylic (meth)acrylate oligomers (sometimes also referred to in the art as “acrylic oligomers”) include oligomers which may be described as substances having an oligomeric acrylic backbone which is functionalized with one or (meth)acrylate groups (which may be at a terminus of the oligomer or pendant to the acrylic backbone). The acrylic backbone may be a homopolymer, random copolymer or block copolymer comprised of repeating units of acrylic monomers. The acrylic monomers may be any monomeric (meth)acrylate such as C1-C6 alkyl (meth)acrylates as well as functionalized (meth)acrylates such as (meth)acrylates bearing hydroxyl, carboxylic acid and/or epoxy groups. Acrylic (meth)acrylate oligomers may be prepared using any procedures known in the art, such as by oligomerizing monomers, at least a portion of which are functionalized with hydroxyl, carboxylic acid and/or epoxy groups (e.g., hydroxyalkyl(meth)acrylates, (meth)acrylic acid, glycidyl (meth)acrylate) to obtain a functionalized oligomer intermediate, which is then reacted with one or more (meth)acrylate-containing reactants to introduce the desired (meth)acrylate functional groups.

Exemplary (meth)acrylate-functionalized monomers and oligomers may include ethoxylated bisphenol A di(meth)acrylates; triethylene glycol di(meth)acrylate; ethylene glycol di(meth)acrylate; tetraethylene glycol di(meth)acrylate; polyethylene glycol di(meth)acrylates; 1,4-butanediol diacrylate; 1,4-butanediol dimethacrylate; diethylene glycol diacrylate; diethylene glycol dimethacrylate, 1,6-hexanediol diacrylate; 1,6-hexanediol dimethacrylate; neopentyl glycol diacrylate; neopentyl glycol di(meth)acrylate; polyethylene glycol (600) dimethacrylate (where 600 refers to the approximate number average molecular weight of the polyethylene glycol portion); polyethylene glycol (200) diacrylate; 1,12-dodecanediol dimethacrylate; tetraethylene glycol diacrylate; triethylene glycol diacrylate, 1,3-butylene glycol dimethacrylate, tripropylene glycol diacrylate, polybutadiene diacrylate; methyl pentanediol diacrylate; polyethylene glycol (400) diacrylate; ethoxylated₂ bisphenol A dimethacrylate; ethoxylated₃ bisphenol A dimethacrylate; ethoxylated₃ bisphenol A diacrylate; cyclohexane dimethanol dimethacrylate; cyclohexane dimethanol diacrylate; ethoxylated₁₀ bisphenol A dimethacrylate (where the numeral following “ethoxylated” is the average number of oxyalkylene moieties per molecule); dipropylene glycol diacrylate; ethoxylated₄ bisphenol A dimethacrylate; ethoxylated₆ bisphenol A dimethacrylate; ethoxylated₈ bisphenol A dimethacrylate; alkoxylated hexanediol diacrylates; alkoxylated cyclohexane dimethanol diacrylate; dodecane diacrylate; ethoxylated₄ bisphenol A diacrylate; ethoxylated₁₀ bisphenol A diacrylate; polyethylene glycol (400) dimethacrylate; polypropylene glycol (400) dimethacrylate; metallic diacrylates; modified metallic diacrylates; metallic dimethacrylates; polyethylene glycol (1000) dimethacrylate; methacrylated polybutadiene; propoxylated₂ neopentyl glycol diacrylate; ethoxylated₃₀ bisphenol A dimethacrylate; ethoxylated₃₀ bisphenol A diacrylate; alkoxylated neopentyl glycol diacrylates; polyethylene glycol dimethacrylates; 1,3-butylene glycol diacrylate; ethoxylated₂ bisphenol A dimethacrylate; dipropylene glycol diacrylate; ethoxylated₄ bisphenol A diacrylate; polyethylene glycol (600) diacrylate; polyethylene glycol (1000) dimethacrylate; tricyclodecane dimethanol diacrylate; propoxylated₂ neopentyl glycol diacrylate; diacrylates of alkoxylated aliphatic alcohols trimethylolpropane trimethacrylate; trimethylolpropane triacrylate; tris (2-hydroxyethyl) isocyanurate triacrylate; ethoxylated₂₀ trimethylolpropane triacrylate; pentaerythritol triacrylate; ethoxylated₃ trimethylolpropane triacrylate; propoxylated₃ trimethylolpropane triacrylate; ethoxylated₆ trimethylolpropane triacrylate; propoxylated₆ trimethylolpropane triacrylate; ethoxylated₉ trimethylolpropane triacrylate; alkoxylated trifunctional acrylate esters; trifunctional methacrylate esters; trifunctional acrylate esters; propoxylated₃ glyceryl triacrylate; propoxylated₅₅ glyceryl triacrylate; ethoxylated₁₅ trimethylolpropane triacrylate; trifunctional phosphoric acid esters; trifunctional acrylic acid esters; pentaerythritol tetraacrylate; di-trimethylolpropane tetraacrylate; ethoxylated₄ pentaerythritol tetraacrylate; pentaerythrilol polyoxyethylene tetraacrylate; dipentaerythritol pentaacrylate; pentaacrylate esters; epoxy acrylate oligomers; epoxy methacrylate oligomers; urethane acrylate oligomers; urethane methacrylate oligomers; polyester acrylate oligomers; polyester methacrylate oligomers; stearyl methacrylate oligomer; acrylic acrylate oligomers; perfluorinated acrylate oligomers; perfluorinated methacrylate oligomers; amino acrylate oligomers; amine-modified polyether acrylate oligomers; and amino methacrylate oligomers.

The curable compositions of the present invention may optionally comprise one or more (meth)acrylate-functionalized compounds containing a single acrylate or methacrylate functional group per molecule (referred to herein as “mono(meth)acrylate-functionalized compounds”). Any of such compounds known in the art may be used.

Examples of suitable mono(meth)acrylate-functionalized compounds include, but are not limited to, mono-(meth)acrylate esters of aliphatic alcohols (wherein the aliphatic alcohol may be straight chain, branched or alicyclic and may be a mono-alcohol, a di-alcohol or a polyalcohol, provided only one hydroxyl group is esterified with (meth)acrylic acid); mono-(meth)acrylate esters of aromatic alcohols (such as phenols, including alkylated phenols); mono-(meth)acrylate esters of alkylaryl alcohols (such as benzyl alcohol); mono-(meth)acrylate esters of oligomeric and polymeric glycols such as diethylene glycol, triethylene glycol, dipropylene glycol, tripropylene glycol, polyethylene glycol, and polypropylene glycol); mono-(meth)acrylate esters of monoalkyl ethers of glycols, oligomeric glycols, polymeric glycols; mono-(meth)acrylate esters of alkoxylated (e.g., ethoxylated and/or propoxylated) aliphatic alcohols (wherein the aliphatic alcohol may be straight chain, branched or alicyclic and may be a mono-alcohol, a di-alcohol or a polyalcohol, provided only one hydroxyl group of the alkoxylated aliphatic alcohol is esterified with (meth)acrylic acid); mono-(meth)acrylate esters of alkoxylated (e.g., ethoxylated and/or propoxylated) aromatic alcohols (such as alkoxylated phenols); caprolactone mono(meth)acrylates; and the like.

The following compounds are specific examples of mono(meth)acrylate-functionalized compounds suitable for use in the curable compositions of the present invention: methyl (meth)acrylate; ethyl (meth)acrylate; n-propyl (meth)acrylate; n-butyl (meth)acrylate; isobutyl (meth)acrylate; n-hexyl (meth)acrylate; 2-ethylhexyl (meth)acrylate; n-octyl (meth)acrylate; isooctyl (meth)acrylate; n-decyl (meth)acrylate; n-dodecyl (meth)acrylate; tridecyl (meth)acrylate; tetradecyl (meth)acrylate; hexadecyl (meth)acrylate; 2-hydroxyethyl (meth)acrylate; 2- and 3-hydroxypropyl (meth)acrylate; 2-methoxyethyl (meth)acrylate; 2-ethoxyethyl (meth)acrylate; 2- and 3-ethoxypropyl (meth)acrylate; tetrahydrofurfuryl (meth)acrylate; alkoxylated tetrahydrofurfuryl (meth)acrylate; isobornyl (meth)acrylate; 2-(2-ethoxyethoxy)ethyl (meth)acrylate; cyclohexyl (meth)acrylate; glycidyl (meth)acrylate; isodecyl (meth)acrylate: 2-phenoxyethyl (meth)acrylate: lauryl (meth)acrylate; isobornyl (meth)acrylate; 2-phenoxyethyl (meth)acrylate; alkoxylated phenol (meth)acrylates; alkoxylated nonylphenol (meth)acrylates; cyclic trimethylolpropane formal (meth)acrylate; trimethylcyclohexanol (meth)acrylate; diethylene glycol monomethyl ether (meth)acrylate; diethylene glycol monoethyl ether (meth)acrylate; diethylene glycol monobutyl ether (meth)acrylate; triethylene glycol monoethyl ether (meth)acrylate; ethoxylated lauryl (meth)acrylate; methoxy polyethylene glycol (meth)acrylates; and combinations thereof.

In certain embodiments of the invention, the curable compositions described herein include at least one photoinitiator and are curable with radiant energy. A photoinitiator may be considered any type of substance that, upon exposure to radiation (e.g., actinic radiation), forms species that initiate the reaction and curing of polymerizing organic substances present in the curable composition. Suitable photoinitiators include both free radical photoinitiators as well as cationic photoinitiators and combinations thereof.

Free radical polymerization initiators are substances that form free radicals when irradiated. The use of free radical photoinitiators is especially preferred. Non-limiting types of free radical photoinitiators suitable for use in the curable compositions of the present invention include, for example, benzoins, benzoin ethers, acetophenones, benzyl, benzyl ketals, anthraquinones, phosphine oxides, α-hydroxyketones, phenylglyoxylates, α-aminoketones, benzophenones, thioxanthones, xanthones, acridine derivatives, phenazene derivatives, quinoxaline derivatives and triazine compounds.

The amount of photoinitiator may be varied as may be appropriate depending upon the photoinitiator(s) selected, the amounts and types of polymerizable species present in the curable composition, the radiation source and the radiation conditions used, among other factors. Typically, however, the amount of photoinitiator may be from 0.05% to 5%, preferably 0.1% to 2% by weight, based on the total weight of the curable composition.

In certain embodiments of the invention, the curable compositions described herein do not include any initiator and are curable (at least in part) with electron beam energy. In other embodiments, the curable compositions described herein include at least one free radical initiator that decomposes when heated or in the presence of an accelerator and are curable chemically (i.e., without having to expose the curable composition to radiation). The at least one free radical initiator that decomposes when heated or in the presence of an accelerator may, for example, comprise a peroxide or azo compound. Suitable peroxides for this purpose may include any compound, in particular any organic compound, that contains at least one peroxy (—O—O—) moiety, such as, for example, dialkyl, diaryl and aryl/alkyl peroxides, hydroperoxides, percarbonates, peresters, peracids, acyl peroxides and the like. The at least one accelerator may comprise, for example, at least one tertiary amine and/or one or more other reducing agents based on metal-containing salts (such as, for example, carboxylate salts of transition metals such as iron, cobalt, manganese, vanadium and the like and combinations thereof). The accelerator(s) may be selected so as to promote the decomposition of the free radical initiator at room or ambient temperature to generate active free radical species, such that curing of the curable composition is achieved without having to heat or bake the curable composition. In other embodiments, no accelerator is present and the curable composition is heated to a temperature effective to cause decomposition of the free radical initiator and to generate free radical species which initiate curing of the polymerizable compound(s) present in the curable composition.

Thus, in various embodiments of the present invention, the curable compositions described herein are curable by techniques selected from the group consisting of radiation curing (e.g., UV radiation or electron beam curing, including LED curing), chemical curing (using a free radical initiator that decomposes when heated or in the presence of an accelerator, e.g., peroxide curing), heat curing or combinations thereof. For example, a curable composition may be cured by first exposing the curable composition to radiation (e.g., ultraviolet radiation) to obtain a partially cured article, when is then heated at an elevated temperature to effect more complete curing (i.e., further reaction of polymerizing species present in the partially cured article).

The curable compositions of the present invention may optionally contain one or more additives instead of or in addition to the above-mentioned ingredients. Such additives include, but are not limited to, antioxidants/photostabilizers, light blockers/absorbers, polymerization inhibitors, foam inhibitors, flow or leveling agents, colorants, pigments, dispersants (wetting agents, surfactants), slip additives, fillers, chain transfer agents, thixotropic agents, matting agents, impact modifiers (other than the multistage polymers and oligomeric polymerizing organic substances already mentioned), waxes or other various additives, including any of the additives conventionally utilized in the coating, sealant, adhesive, molding, 3D printing or ink arts.

To protect against premature gelling or curing of the curable composition, particularly in the presence of oxygen or other oxidant, one or more antioxidants may be included in the curable composition. Any of the antioxidants known in the art may be utilized, including for example phenol-based antioxidants, phosphorus-based antioxidants, quinone-type antioxidants and combinations thereof.

Typically, one or more antioxidants may be included in the curable composition in a total amount of up to 4% by weight, e.g., 0.05 to 2% by weight, based on the weight of the curable composition.

The curable compositions of the present invention may comprise one or more light blockers (sometimes referred to in the art as absorbers), particularly where the curable composition is to be used as a resin in a three-dimensional printing method involving photocuring of the curable composition. The light blocker(s) may be any such substances known in the three-dimensional printing art, including for example non-reactive pigments and dyes. The light blocker may be a visible light blocker or a UV light blocker, for example. Examples of suitable light blockers include, but are not limited to, titanium dioxide, carbon black and organic ultraviolet light absorbers such as hydroxybenzophenone, hydroxyphenylbenzotriazole, oxanilide, benzophenone, thioxanthone, hydroxyphenyltriazine, Sudan I, bromothymol blue, 2,2′-(2,5-thiophenediyl)bis(5-tert-butylbenzoxazole) (sold under the brand name “Benetex OB Plus”) and benzotriazole ultraviolet light absorbers.

The amount of light blocker may be varied as may be desired or appropriate for particular applications. Generally speaking, if the curable composition contains light blocker, it is present in a concentration of from 0.001 to 10% by weight based on the weight of the curable composition.

Advantageously, the curable compositions of the present invention may be formulated to be solvent-free, i.e., free of any non-reactive volatile substances (substances having a boiling point at atmospheric pressure of 150° C. or less). For example, the curable compositions of the present invention may contain little or no non-reactive solvent, e.g., less than 10% or less than 5% or less than 1% or even 0% non-reactive solvent, based on the total weight of the curable composition. Such solvent-less or low-solvent compositions may be formulated using various components, including for example low viscosity reactive diluents, which are selected so as to render the curable composition sufficiently low in viscosity, even without solvent being present, that the curable composition can be easily applied at a suitable application temperature to a substrate surface so as to form a relatively thin, uniform layer.

In preferred embodiments of the invention, the curable composition is a liquid at 25° C. In various embodiments of the invention, the curable compositions described herein are formulated to have a viscosity of less than 10,000 mPa·s (cP), or less than 5000 mPa·s (cP), or less than 4000 mPa·s (cP), or less than 3000 mPa·s (cP), or less than 2500 mPa·s (cP), or less than 2000 mPa·s (cP), or less than 1500 mPa·s (cP), or less than 1000 mPa·s (cP) or even less than 500 mPa·s (cP) as measured at 25° C. using a Brookfield viscometer, model DV-II, using a 27 spindle (with the spindle speed varying typically between 20 and 200 rpm, depending on viscosity). In advantageous embodiments of the invention, the viscosity of the curable composition is from 200 to 5000 mPa·s (cP), or from 200 to 2000 mPa·s (cP), or from 200 to 1500 mPa·s (cP), or from 200 to 1000 mPa·s (cP) at 25° C. Relatively high viscosities can provide satisfactory performance in applications where the curable composition is heated above 25° C., such as in three-dimensional printing operations or the like which employ machines having heated resin vats.

The curable compositions described herein may be compositions that are to be subjected to curing by means of free radical polymerization, cationic polymerization or other types of polymerization. In particular embodiments, the curable compositions are photocured (i.e., cured by exposure to actinic radiation such as light, in particular visible or UV light). End use applications for the curable compositions include, but are not limited to, inks, coatings, adhesives, 3D printing resins, molding resins, sealants, composites, antistatic layers, electronic applications, recyclable materials, smart materials capable of detecting and responding to stimuli, and biomedical materials.

Cured compositions prepared from curable compositions as described herein may be used, for example, in three-dimensional articles (wherein the three-dimensional article may consist essentially of or consist of the cured composition), coated articles (wherein a substrate is coated with one or more layers of the cured composition, including encapsulated articles in which a substrate is completely encased by the cured composition), laminated or adhered articles (wherein a first component of the article is laminated or adhered to a second component by means of the cured composition), composite articles or printed articles (wherein graphics or the like are imprinted on a substrate, such as a paper, plastic or M-containing substrate, using the cured composition).

Curing of the curable compositions in accordance with the present invention may be carried out by any suitable method, such as free radical and/or cationic polymerization. One or more initiators, such as a free radical initiator (e.g., photoinitiator, peroxide initiator) may be present in the curable composition. Prior to curing, the curable composition may be applied to a substrate surface in any known conventional manner, for example, by spraying, knife coating, roller coating, casting, drum coating, dipping, and the like and combinations thereof. Indirect application using a transfer process may also be used. A substrate may be any commercially relevant substrate, such as a high surface energy substrate or a low surface energy substrate, such as a metal substrate or plastic substrate, respectively. The substrates may comprise metal, paper, cardboard, glass, thermoplastics such as polyolefins, polycarbonate, acrylonitrile butadiene styrene (ABS), and blends thereof, composites, wood, leather and combinations thereof. When used as an adhesive, the curable composition may be placed between two substrates and then cured, the cured composition thereby bonding the substrates together to provide an adhered article. Curable compositions in accordance with the present invention may also be formed or cured in a bulk manner (e.g., the curable composition may be cast into a suitable mold and then cured).

Curing may be accelerated or facilitated by supplying energy to the curable composition, such as by heating the curable composition and/or by exposing the curable composition to a radiation source, such as visible or UV light, infrared radiation, and/or electron beam radiation. Thus, the cured composition may be deemed the reaction product of the curable composition, formed by curing. A curable composition may be partially cured by exposure to actinic radiation, with further curing being achieved by heating the partially cured article. For example, an article formed from the curable composition (e.g., a 3D printed article) may be heated at a temperature of from 40° C. to 120° C. for a period of time of from 5 minutes to 12 hours.

A plurality of layers of a curable composition in accordance with the present invention may be applied to a substrate surface; the plurality of layers may be simultaneously cured (by exposure to a single dose of radiation, for example) or each layer may be successively cured before application of an additional layer of the curable composition.

The curable compositions which are described herein are especially well-suited for use as resins in three-dimensional printing applications. Three-dimensional (3D) printing (also referred to as additive manufacturing) is a process in which a 3D digital model is manufactured by the accretion of construction material. The 3D printed object is created by utilizing the computer-aided design (CAD) data of an object through sequential construction of two dimensional (2D) layers or slices that correspond to cross-sections of 3D objects. Stereolithography (SL) is one type of additive manufacturing where a liquid resin is hardened by selective exposure to a radiation to form each 2D layer. The radiation can be in the form of electromagnetic waves or an electron beam. The most commonly applied energy source is ultraviolet, visible or infrared radiation.

The inventive curable compositions described herein may be used as 3D printing resin formulations, that is, compositions intended for use in manufacturing three-dimensional articles using 3D printing techniques. Such three-dimensional articles may be free-standing/self-supporting and may consist essentially of or consist of a composition in accordance with the present invention that has been cured. The three-dimensional article may also be a composite, comprising at least one component consisting essentially of or consisting of a cured composition as previously mentioned as well as at least one additional component comprised of one or more materials other than such a cured composition (for example, a metal component or a thermoplastic component). The curable compositions of the present invention are particularly useful in digital light printing (DLP), although other types of three-dimensional (3D) printing methods may also be practiced using the inventive curable compositions (e.g., SLA, inkjet). The curable compositions of the present invention may be used in a three-dimensional printing operation together with another material which functions as a scaffold or support for the article formed from the curable composition of the present invention.

A method of making a three-dimensional article using a curable composition in accordance with the present invention may comprise the steps of:
a) providing (e.g., coating) a first layer of a curable composition in accordance with the present invention onto a surface;
b) curing the first layer, at least partially, to provide a cured first layer;
c) providing (e.g., coating) a second layer of the curable composition onto the cured first layer;
d) curing the second layer, at least partially, to provide a cured second layer adhered to the cured first layer; and
e) repeating steps c) and d) a desired number of times to build up the three-dimensional article.

Although the curing steps may be carried out by any suitable means, which will in some cases be dependent upon the components present in the curable composition, in certain embodiments of the invention the curing is accomplished by exposing the layer to be cured to an effective amount of radiation, in particular actinic radiation (e.g., electron beam radiation, UV radiation, visible light, etc.). The three-dimensional article which is formed may be heated in order to effect thermal curing.

Accordingly, in various embodiments, the present invention provides a process comprising the steps of:
a) providing (e.g., coating) a first layer of a curable composition in accordance with the present invention and in liquid form onto a surface;
b) exposing the first layer imagewise to actinic radiation to form a first exposed imaged cross-section, wherein the radiation is of sufficient intensity and duration to cause at least partial curing (e.g., at least 50% curing, as measured by the % conversion of the polymerizable functional groups initially present in the curable composition) of the layer in the exposed areas;
c) providing (e.g., coating) an additional layer of the curable composition onto the previously exposed imaged cross-section;
d) exposing the additional layer imagewise to actinic radiation to form an additional imaged cross-section, wherein the radiation is of sufficient intensity and duration to cause at least partial curing (e.g., at least 50% curing, as measured by the % conversion of the polymerizable functional groups initially present in the curable composition) of the additional layer in the exposed areas and to cause adhesion of the additional layer to the previously exposed imaged cross-section;
e) repeating steps c) and d) a desired number of times to build up the three-dimensional article.

Thus, the curable compositions of the present invention are useful in the practice of various types of three-dimensional fabrication or printing techniques, including methods in which construction of a three-dimensional object is performed in a step-wise or layer-by-layer manner. In such methods, layer formation may be performed by solidification (curing) of the curable composition under the action of exposure to radiation, such as visible, UV or other actinic irradiation. For example, new layers may be formed at the top surface of the growing object or at the bottom surface of the growing object. The curable compositions of the present invention may also be advantageously employed in methods for the production of three-dimensional objects by additive manufacturing wherein the method is carried out continuously. For example, the object may be produced from a liquid interface. Suitable methods of this type are sometimes referred to in the art as “continuous liquid interface (or interphase) product (or printing)” (“CLIP”) methods. Such methods are described, for example, in WO 2014/126830; WO 2014/126834; WO 2014/126837; and Tumbleston et al., “Continuous Liquid Interface Production of 3D Objects,” Science Vol. 347, Issue 6228, pp. 1349-1352 (Mar. 20, 2015), the entire disclosure of which is incorporated herein by reference in its entirety for all purposes.

When stereolithography is conducted above an oxygen-permeable build window, the production of an article using a curable composition in accordance with the present invention may be enabled in a CLIP procedure by creating an oxygen-containing “dead zone” which is a thin uncured layer of the curable composition between the window and the surface of the cured article as it is being produced. In such a process, a curable composition is used in which curing (polymerization) is inhibited by the presence of molecular oxygen; such inhibition is typically observed, for example, in curable compositions which are capable of being cured by free radical mechanisms. The dead zone thickness which is desired may be maintained by selecting various control parameters such as photon flux and the optical and curing properties of the curable composition. The CLIP process proceeds by projecting a continuous sequence of actinic radiation (e.g., UV) images (which may be generated by a digital light-processing imaging unit, for example) through an oxygen-permeable, actinic radiation- (e.g., UV-) transparent window below a bath of the curable composition maintained in liquid form. A liquid interface below the advancing (growing) article is maintained by the dead zone created above the window. The curing article is continuously drawn out of the curable composition bath above the dead zone, which may be replenished by feeding into the bath additional quantities of the curable composition to compensate for the amounts of curable composition being cured and incorporated into the growing article.

For example, printing of a three-dimensional article using the curable compositions described herein may be carried out by a process comprising at least the following steps:
a) providing a carrier and an optically transparent member having a build surface, the carrier and build surface defining a build region therebetween;
b) filling the build region with the curable composition;
c) continuously or intermittently irradiating the build region with actinic radiation to form a cured composition from the curable composition; and
d) continuously or intermittently advancing the carrier away from the build surface to form the three-dimensional article from the cured composition.

The present invention also provides a method of forming a three-dimensional article comprising the steps of: (a) providing a carrier and a build plate, the build plate comprising a semipermeable member, the semipermeable member comprising a build surface and a feed surface separate from the build surface, with the build surface and the carrier defining a build region therebetween, and with the feed surface in fluid contact with a polymerization inhibitor; then (concurrently and/or sequentially) (b) filling the build region with a curable composition in accordance with the invention, the curable composition contacting the build segment, (c) irradiating the build region through the build plate to produce a solid polymerized region in the build region, with a liquid film release layer comprised of the curable composition formed between the solid polymerized region and the build surface, the polymerization of the liquid film being inhibited by the polymerization inhibitor; and (d) advancing the carrier with the polymerized region adhered thereto away from the build surface on the stationary build plate to create a subsequent build region between the polymerized region and the top zone. In general, the method includes (e) continuing and/or repeating steps (b) through (d) to produce a subsequent polymerized region adhered to a previous polymerized region until the continued or repeated deposition of polymerized regions adhered to one another forms the three-dimensional article.

Also within the scope of the present invention are curable compositions in which one or more (meth)acrylate-functionalized branched polyalpha-olefins in accordance with the invention are the only (meth)acrylate-functionalized compounds present in the curable composition. Such curable compositions may, however, be formulated with one or more additional components, such as free radical initiators, fillers, stabilizers and other additives as described above.

### Crosslinkable Resin Compositions

As previously mentioned, the (meth)acrylate-functionalized branched polyalpha-olefins of the present invention may be used as coagents in the crosslinking of polymers, especially thermoplastic polymers (including thermoplastic elastomers), in particular nonpolar polymers such as nonpolar thermoplastic polymers (e.g., polyolefins). The properties and characteristics of polymers may be modified through such crosslinking. Examples of such polyolefins include ethylene homopolymers, copolymers of ethylene with one or more other olefins, homopolymers of propylene, and copolymers of propylene and one or more other olefin polymers. For example, the polyolefin to be crosslinked using the (meth)acrylate-functionalized branched polyalpha-olefin may be low density polyethylene (LDPE), linear low density polyethylene (LLDPE), or high density polyethylene (HDPE). Elastomers and rubbers may also be crosslinked using the (meth)acrylate-functionalized branched polyalpha-olefins of the present invention. Examples of such rubbers and elastomers include, but are not limited to, polyolefinic elastomers (POE), ethylene propylene diene rubbers (EPDM), polyisobutylene, diene-based rubbers such as polybutadiene, polyisoprene, copolymers of butadienes and one or more other monomers (such as styrene), and copolymers of isoprene and one or more other monomers. Other types of polymers in which the (meth)acrylate-functionalized branched polyalpha-olefin may be used as a coagent include ethylene vinyl acetate copolymers, polyamides, and homopolymers and copolymers of alkyl(meth)acrylates.

A resin composition suitable for crosslinking (i.e., a crosslinkable resin composition) may be prepared by combining at least one polymer and at least one (meth)acrylate-functionalized branched polyalpha-olefin in accordance with the present invention. Typically, the (meth)acrylate-functionalized branched polyalpha-olefin is present at relatively low concentrations in such crosslinkable resin compositions. For example, the crosslinkable resin composition may comprise at least 0.1, at least 0.5, at least 1, at least 1.5 or at least 2 phr (meth)acrylate-functionalized branched polyalpha-olefin (phr=parts by weight per 100 parts by weight of polymer). In other embodiments, the crosslinkable resin composition may comprise up to 25, up to 20 or up to 15 phr (meth)acrylate-functionalized branched polyalpha-olefin. According to one embodiment, the crosslinkable resin composition is comprised of from 1 to 20 phr of (meth)acrylate-functionalized branched polyalpha-olefin. Relatively high loadings of (meth)acrylate-functionalized branched polyalpha-olefin are possible, even in nonpolar polymers such as polyolefins, due to the more hydrophobic character of the (meth)acrylate-functionalized polyalpha-olefin of the present invention, as compared to the coagents conventionally used for crosslinking polymers (e.g., low molecular weight triallyl compounds). That is, the (meth)acrylate-functionalized branched polyalpha-olefin is highly compatible with nonpolar polymers generally, thus permitting crosslinkable resin compositions to be formulated which are comparatively homogeneous and which exhibit little or no exudation of the (meth)acrylate-functionalized branched polyalpha-olefin.

The crosslinkable resin composition may be formulated with at least one free radical initiator which is capable of initiating crosslinking reactions involving the polymer and the (meth)acrylate-functionalized branched polyalpha-olefin. Such free radical initiators may, for example, be heat activated. Peroxides, in particular organic peroxides, represent a suitable type of free radical initiator. The amount of peroxide in the crosslinkable resin composition may vary, depending upon the reactivity of the peroxide and the degree of crosslinking desired, for example. Generally speaking, the crosslinkable resin composition may comprise at least 0.01, at least 0.05 or at least 0.1 phr peroxide, but not more than 5, not more than 4, not more 3, not more than 2 or not more than 1 phr peroxide, according to various embodiments of the invention. For example, the crosslinkable resin composition may be comprised of 0.01 to 5 phr peroxide. Suitable types of peroxides for this purpose include, for example, dialkyl peroxides, diacyl peroxides, alkyl hydroperoxides, aralkyl hydroperoxides, alkylaryl peroxides, peroxyesters, peroxyacids, peroxycarbonates, peroxyketals, and the like and combinations thereof.

Other components may additionally be present in the crosslinkable resin composition including, but not limited to, coagents other than the (meth)acrylate-functionalized branched polyalpha-olefin, scorch retarders, peroxide scavengers, antioxidants, stabilizers, accelerators/promoters for the free radical initiator, pigments/dyes, fillers and the like and combinations thereof. The various components of the crosslinkable resin composition may be combined and melt compounded to provide the crosslinkable resin composition.

For ease of handling and subsequent forming into the final desired article, the crosslinkable resin composition may be provided in the form of pellets or granules. The crosslinkable resin composition may be formed into a film, sheet, three dimensional article or the like.

Crosslinking of the crosslinkable resin composition may be accomplished by any suitable means known in the art. For example, both chemical crosslinking and physical crosslinking methods may be employed. One such method involves reacting the polymer with one or more free radical initiators such as peroxides, including those previously described. Typically, such reactions are initiated by heating the crosslinkable resin composition to a temperature effective to cause decomposition of the peroxide into free radical species. In a still further method, radiation curing is utilized wherein the crosslinkable resin composition is exposed to radiation, such as gamma rays or electron beam radiation. In such a method, the crosslinkable resin composition need not be heated to effect crosslinking.

The crosslinkable resin compositions of the present invention may advantageously provide crosslinked polymeric resins useful in the fabrication of crosslinked films, crosslinked sheets, crosslinked wire and cable coverings, crosslinked containers, crosslinked liners, crosslinked coatings, crosslinked pipe, and the like.

Various non-limiting aspects of the present invention may be summarized as follows:

Aspect 1: A (meth)acrylate-functionalized branched polyalpha-olefin comprising the reaction product of, at least, a) a (meth)acrylate source and b) a hydroxyl-functionalized branched polymerizate of, at least, i) one or more alpha-olefin monomers having at least six carbon atoms per molecule and ii) one or more unsaturated hydroxyl-functionalized comonomers, wherein one or more of the hydroxyl functional groups of the hydroxyl-functionalized branched polymerizate are converted to (meth)acrylate functional groups.

Aspect 2: The (meth)acrylate-functionalized branched polyalpha-olefin of Aspect 1, wherein the one or more alpha-olefin monomers include one or more alpha-olefin monomers having at least ten carbon atoms per molecule

Aspect 3: The (meth)acrylate-functionalized branched polyalpha-olefin of Aspect 1 or 2, wherein the hydroxyl-functionalized branched polymerizate has an average of at least three hydroxyl functional groups per molecule.

Aspect 4: The (meth)acrylate-functionalized branched polyalpha-olefin of any of Aspects 1 to 3, wherein the at least one unsaturated hydroxyl-functionalized comonomer includes at least one unsaturated hydroxyl-functionalized comonomer in accordance with Formula (I) or Formula (II):

HR¹C═CH—(R²)—CH₂OH (I)

HR¹C═CH—(R²)—CH₂—(OR³)ₘOH (II)

wherein m is an integer of 1 to 20, R¹ is H or a C₁-C₂₀ alkyl group, R² is a direct bond or a divalent C₁-C₂₀ alkylene group, and R³ is a divalent C₂-C₄ alkylene group.

Aspect 5: The (meth)acrylate-functionalized branched polyalpha-olefin of any of Aspects 1 to 4, wherein the at least one unsaturated hydroxyl-functionalized comonomer includes at least one unsaturated hydroxyl-functionalized comonomer in accordance with Formula (Ia) or Formula (IIb):

H₂C═CH(CH₂)ₙ—OH (Ia)

H₂C═CH(CH₂)ₙ—(OCH₂CHR)ₘOH (IIb)

wherein n is an integer of 1 to 24, m is an integer of 1 to 5, and R³ is —CH₂CH₂—, —CH₂C(CH₃)H—, or —C(CH₃)HCH₂—, wherein when m is 2 or greater each R³ may be the same or different.

Aspect 6: The (meth)acrylate-functionalized branched polyalpha-olefin of any of Aspects 1 to 5, wherein the at least one unsaturated hydroxyl-functionalized comonomer includes at least one unsaturated hydroxyl-functionalized comonomer selected from the group consisting of allyl alcohol, 5-hexen-1-ol, 3-hexen-1-ol, 4-penten-1-ol, 3-penten-1-ol, 3-buten-1-ol, crotyl alcohol, elaidyl alcohol, gadoleyl alcohol, 9-decen-1-ol, 9-dodecen-1-ol, 10-undecylenyl alcohol, oleyl alcohol, erucyl alcohol, brassidyl alcohol, ethoxylated and/or propoxylated derivatives thereof, and combinations thereof.

Aspect 7: The (meth)acrylate-functionalized branched polyalpha-olefin of any of Aspects 1 to 6, wherein the at least one alpha-olefin monomer having at least six carbon atoms includes at least one alpha-olefin monomer selected from the group consisting of 1-decene, 1-dodecene, 1-tetradecene, 1-hexadecene, 1-octadecene, 1-eicosene, and combinations thereof.

Aspect 8: The (meth)acrylate-functionalized branched polyalpha-olefin of any of Aspects 1 to 7, wherein the at least one alpha-olefin monomer having at least six carbon atoms is a mixture of alpha-olefin monomers having chain lengths selected from the group consisting of C₁₀-C₁₃, C₂₀-C₂₄, C₂₄-C₂₈, and C₃₀ and higher chain lengths.

Aspect 9: The (meth)acrylate-functionalized branched polyalpha-olefin of any of Aspects 1 to 8, wherein the (meth)acrylate-functionalized branched polyalpha-olefin has a number average molecular weight of from 500 to 10,000 daltons.

Aspect 10: The (meth)acrylate-functionalized branched polyalpha-olefin of any of Aspects 1 to 9, wherein the (meth)acrylate source is selected from the group consisting of (meth)acrylic acid, (meth)acrylic anhydride, (meth)acryloyl halides, and C₁-C₄ esters of (meth)acrylic acid.

Aspect 11: The (meth)acrylate-functionalized branched polyalpha-olefin of any of Aspects 1 to 10, wherein the (meth)acrylate-functionalized branched polyalpha-olefin contains from 1 to 8 (meth)acrylate functional groups per molecule.

Aspect 12: The (meth)acrylate-functionalized branched polyalpha-olefin of any of Aspects 1 to 11, wherein at least 80% of the hydroxyl functional groups of the hydroxyl-functionalized branched polymerizate are converted to (meth)acrylate functional groups.

Aspect 13: The (meth)acrylate-functionalized branched polyalpha-olefin of any of Aspects 1 to 12, wherein the hydroxyl-functionalized branched polymerizate has a hydroxyl equivalent weight of from 200 to 2000 grams per hydroxyl equivalent.

Aspect 14: The (meth)acrylate-functionalized branched polyalpha-olefin of any of Aspects 1 to 13, wherein the hydroxyl-functionalized branched polymerizate has been obtained from an ester-functionalized branched polymerizate of, at least, i) one or more alpha-olefin monomers having at least six carbon atoms per molecule and ii) one or more unsaturated ester-functionalized comonomers, wherein one or more of the ester functional groups present in the ester-functionalized branched polymerizate have been converted to hydroxyl functional groups.

Aspect 15: A method of preparing a (meth)acrylate-functionalized branched polyalpha-olefin, comprising reacting a (meth)acrylate source and a hydroxyl-functionalized branched polymerizate of, at least, i) at least one alpha-olefin monomer having at least six carbon atoms per molecule and ii) at least one unsaturated hydroxyl-functionalized comonomer, wherein one or more of the hydroxyl functional groups of the hydroxyl-functionalized branched polymerizate are converted to (meth)acrylate functional groups.

Aspect 16: A (meth)acrylate-functionalized branched polyalpha-olefin comprised of a plurality of repeating units A in accordance with Formula (III) and a plurality of repeating units B in accordance with Formula (IV):

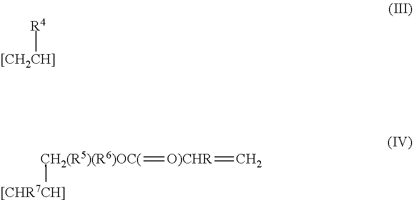

wherein R is H or methyl, R⁴ is an alkyl group comprised of at least four carbon atoms, R⁵ is a direct bond or a divalent alkylene group, R⁶ is optionally present, but if present, is a divalent oxyalkylene group or a divalent poly(oxyalkylene) group, and R⁷ is H or an alkyl group.

Aspect 17: The (meth)acrylate-functionalized branched polyalpha-olefin of Aspect 16, wherein the (meth)acrylate-functionalized branched polyalpha-olefin is comprised of a plurality of repeating units A in accordance with Formula (Ma) and a plurality of repeating units B in accordance with Formula (IVb):

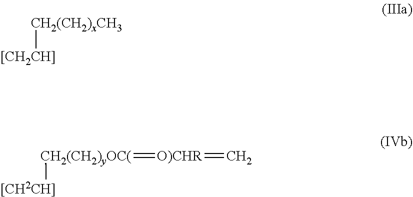

wherein x is an integer of at least 6, y is an integer of at least 0, and R is H or methyl.

Aspect 18: The (meth)acrylate-functionalized branched polyalpha-olefin of Aspect 16 or Aspect 17, wherein the (meth)acrylate-functionalized branched polyalpha-olefin has a number average molecular weight of from 500 to 10,000 daltons.

Aspect 19: The (meth)acrylate-functionalized branched polyalpha-olefin of any of Aspects 16 to 18, wherein the (meth)acrylate-functionalized branched polyalpha-olefin contains from 1 to 8 (meth)acrylate functional groups per molecule.

Aspect 20: A curable composition comprised of a (meth)acrylate-functionalized branched polyalpha-olefin in accordance with any of Aspects 1-14 or 16-19 and at least one (meth)acrylate-functionalized compound other than a (meth)acrylate-functionalized branched polyalpha-olefin in accordance with any of Aspects 1-14 or 16-19.

Aspect 21: The curable composition of Aspect 20, wherein the curable composition is selected from the group consisting of adhesives, sealants, coatings, three dimensional printing and additive manufacturing resins, inks and molding resins.

Aspect 22: A method of making an article, wherein the method comprises a step of exposing the curable composition of Aspect 20 or Aspect 21 to actinic radiation.

Aspect 23: A crosslinkable resin composition comprised of a (meth)acrylate-functionalized branched polyalpha-olefin in accordance with any of Aspects 1-14 and 16-19 and at least one polymer.

Aspect 24: A method of making an article, wherein the method comprises a step of crosslinking the crosslinkable resin composition of Aspect 23.

Within this specification, embodiments have been described in a way which enables a clear and concise specification to be written, but it is intended and will be appreciated that embodiments may be variously combined or separated without departing from the invention. For example, it will be appreciated that all preferred features described herein are applicable to all aspects of the invention described herein.

In some embodiments, the invention herein can be construed as excluding any element or process step that does not materially affect the basic and novel characteristics of the (meth)acrylate-functionalized branched polyalpha-olefins, methods for making the (meth)acrylate-functionalized branched polyalpha-olefins, compositions comprising the (meth)acrylate-functionalized polyalpha-olefins, methods of using the (meth)acrylate-functionalized polyalpha-olefins, and articles prepared using the (meth)acrylate-functionalized polyalpha-olefins. Additionally, in some embodiments, the invention can be construed as excluding any element or process step not specified herein.

Although the invention is illustrated and described herein with reference to specific embodiments, the invention is not intended to be limited to the details shown. Rather, various modifications may be made in the details within the scope and range of equivalents of the claims and without departing from the invention.

### EXAMPLES

### Example 1—Preparation of Acrylate-Functionalized Branched Polyalpha-Olefin

The following were added to a 1000 mL round bottom reaction flask having one center neck and three outer necks: 353 g Vybar® H-6164 (product of Baker Hughes) highly branched polyalpha-olefin composition containing on average more than three hydroxyl groups per molecule and having a hydroxyl equivalent weight of approximately 519 g per equivalent of hydroxyl, 60 g. acrylic acid, 0.7 g 4-methoxyphenol, 180 g. heptane, 1.2 g 50% aq. hypophosphorous acid, and 4.8 g 70% methanesulfonic acid. The reaction flask was equipped with a stirrer shaft/bushing/stirrer motor, a 20 mL capacity side arm and condenser, a thermocouple/adapter placing the tip of the thermocouple below the liquid level, a temperature controller and heating mantle, and an air sparge needle/adapter with the needle inserted below the surface of the liquid. Agitation was started and the reactor heated to reflux. The water generated from the esterification reaction was collected in the sidearm. After 5 hours at reflux, water production stalled; 17 g of water had been collected.

The reaction mixture was cooled to <50° C. and transferred to a 2000 mL washing flask equipped with a stopcocked bottom outlet, a stirring shaft/motor, thermocouple, temperature controller, and heating mantle. The 413 g of heptane were added to the washer and the contents heated to 42 C. Next, 31 g of 25% aqueous NaOH were added to the washer and agitated for two minutes. After settling for 30 minutes, the aqueous phase was removed through the stopcock. The 25% NaOH was repeated. Next, 31 g of water were added to the washer and agitated for two minutes. After settling for 30 minutes, the aqueous phase was removed. The water wash was repeated.

Next, the batch was transferred to a stripping apparatus comprised of a 2000 mL four neck round bottom flask equipped with a stirring shaft, bushing and stirrer motor, a thermocouple, temperature controller and heating mantle, a sidearm/condenser with a 1000 mL single neck round bottom flask as a receiver, and an air sparge tube inserted below the liquid level. To the stripping flask, 0.08 g of 4-methoxyphenol were added. Vacuum at 40 mmHg was applied to the stripping apparatus. The flask was heated to 95° C. as the solvent was distilled out. After the solvent content was reduced to <0.1%, the batch was cooled to ambient temperature.

Multi-detector size exclusion chromatography (SEC) coupled to multi-angle light scattering, differential viscometry, and differential refractometry was used to characterize Vybar® H-6164 and the resulting acrylated materials. The properties of the acrylate-functionalized branched polyalpha-olefin obtained were as follows: viscosity of 433 cP at 25° C., color of 12 Gardner, hazy to cloudy appearance, weight average molecular weight of 4410 daltons, and number average molecular weight of 1550 daltons (relative to polystyrene standards). The values for intrinsic viscosity given in the following Table 1 were obtained using differential viscometry.

TABLE 1

| | [η]_{, n} | [η]_{, w} | [η]_{, z} |
|---|---|---|---|
| Polymer | (mL/g) | (mL/g) | (mL/g) |
| Vybar 6164-H | 4 | 5 | 6 |
| Fully Acrylated Vybar Batch | 3 | 4 | 4 |

The polymer architecture can be determined using two different methods: a Mark-Houwink plot and/or a conformation plot. The intrinsic viscosity and molar mass data are combined to make a Mark-Houwink plot while the viscometric radius and molar mass are combined to make a conformation plot. The slope or various slopes in a Mark-Houwink plot and conformation plot indicate if a polymer is linear or branched in the solvent/temperature conditions used for analysis. In a Mark-Houwink plot, a polymer with a linear random coil architecture has a slope (a value) of 0.5-0.8, while a branched molecule has a slope from 0.33-0.5. In a conformation plot, a polymer with a linear random coil architecture has a slope (1/d_{f}) of 0.50-0.60 and a branched molecule has a slope from 0.33-0.50. The Mark-Houwink plot and conformation plot slopes for the three samples indicate that that the three samples are branched.

Overall, the multi-detector SEC experiments determined that the molar mass of the Vybar 6164-H is less than the fully acrylated Vybar Batch, which is the product of Example 1. Additionally, the polymeric size and instinct viscosity for the two samples are the same, and small compared to polymeric samples typically analyzed by multi-detector SEC. The molecular architecture was determined to be branched based on both the Mark-Houwink plot slope and viscometric radius conformation plot slope, as shown below in Table 2.

TABLE 2

| | α (Mark-Houwink Slope) | Viscosity Conformation |
|---|---|---|
| Polymer | (low to high molar mass) | Plot Slope |
| Vybar H-6164 | 0.19 | 0.40 |
| Fully Acrylated | 0.20 | 0.40 |
| Vybar Batch | | |

### Example 2—Compounding of Acrylate-Functionalized Branched Polyalpha-Olefin into Polyethylene and Electron Beam Curing

The acrylate-functionalized branched polyalpha-olefin obtained in Example 1 was tested as a co-crosslinking agent or coagent to enhance the performance properties of electron beam-cured polyolefin films such as linear low density polyethylene (LLDPE) and ultra low density polyethylene (ULDPE). Initially, Vitamin E (α-tocopherol) was added to the acrylate-functionalized branched polyalpha-olefin as a scorch retarder to prevent the onset of polymerization during the compounding process at high temperatures. The acrylate-functionalized branched polyalpha-olefin was added to LLDPE and ULDPE film grade polymers at 0, 2, 5, 10 and 15% (by weight) coagent loading levels. The acrylate-functionalized branched polyalpha-olefin exhibited good miscibility in the polymers up to 15% loading; no exudate was observed after compounding and strand extrusion in a DSM microextruder at 150° C. extrusion and 140° C. at the extruder die. The extruded strand was chopped into pellets. The pellets were heat-pressed into films in a Carver hydraulic press for electron beam curing of the film and tested for tensile properties and tear resistance.

### Example 3—Use of Acrylate-Functionalized Branched Polyalpha-Olefin in Radiation Curable Adhesives

The acrylate-functionalized branched polyalpha-olefin can be combined with other (meth)acrylate-functionalized compounds. The resulting photocurable resin compositions have been found to have shear adhesion failure temperatures in excess of 400° F. (204° C.). Blends of highly functionalized branched polyalpha-olefins and lower functionalized branched polyalpha-olefins have been found to show some ability to modify peel and tack properties when used together with other (meth)acrylate-functionalized monomer diluents.

1. A (meth)acrylate-functionalized branched polyalpha-olefin comprising the reaction product of, at least, a) a (meth)acrylate source and b) a hydroxyl-functionalized branched polymerizate of, at least, i) one or more alpha-olefin monomers having at least six carbon atoms per molecule and ii) one or more unsaturated hydroxyl-functionalized comonomers, wherein one or more of the hydroxyl functional groups of the hydroxyl-functionalized branched polymerizate are converted to (meth)acrylate functional groups.

2. The (meth)acrylate-functionalized branched polyalpha-olefin of claim 1, wherein the one or more alpha-olefin monomers include one or more alpha-olefin monomers having at least ten carbon atoms per molecule

3. The (meth)acrylate-functionalized branched polyalpha-olefin of claim 1, wherein the hydroxyl-functionalized branched polymerizate has an average of at least three hydroxyl functional groups per molecule.

4. The (meth)acrylate-functionalized branched polyalpha-olefin of claim 1, wherein the at least one unsaturated hydroxyl-functionalized comonomer includes at least one unsaturated hydroxyl-functionalized comonomer in accordance with Formula (I) or Formula (II):
HR¹C═CH—(R²)—CH₂OH (I)
HR¹C═CH—(R²)—CH₂—(OR³)ₘOH (II)
wherein m is an integer of 1 to 20, R¹ is H or a C₁-C₂₀ alkyl group, R² is a direct bond or a divalent C₁-C₂₀ alkylene group, and R³ is a divalent C₂-C₄ alkylene group.

5. The (meth)acrylate-functionalized branched polyalpha-olefin of claim 1, wherein the at least one unsaturated hydroxyl-functionalized comonomer includes at least one unsaturated hydroxyl-functionalized comonomer in accordance with Formula (Ia) or Formula (IIb):
H₂C═CH(CH₂)ₙ—OH (Ia)
H₂C═CH(CH₂)ₙ—(OCH₂CHR)ₘOH (IIb)
wherein n is an integer of 1 to 24, m is an integer of 1 to 5, and R³ is —CH₂CH₂—, —CH₂C(CH₃)H—, or —C(CH₃)HCH₂—, wherein when m is 2 or greater each R³ may be the same or different.

6. The (meth)acrylate-functionalized branched polyalpha-olefin of claim 1, wherein the at least one unsaturated hydroxyl-functionalized comonomer includes at least one unsaturated hydroxyl-functionalized comonomer selected from the group consisting of allyl alcohol, 5-hexen-1-ol, 3-hexen-1-ol, 4-penten-1-ol, 3-penten-1-ol, 3-buten-1-ol, crotyl alcohol, elaidyl alcohol, gadoleyl alcohol, 9-decen-1-ol, 9-dodecen-1-ol, 10-undecylenyl alcohol, oleyl alcohol, erucyl alcohol, brassidyl alcohol, ethoxylated and/or propoxylated derivatives thereof, and combinations thereof.

7. The (meth)acrylate-functionalized branched polyalpha-olefin of claim 1, wherein the at least one alpha-olefin monomer having at least six carbon atoms includes at least one alpha-olefin monomer selected from the group consisting of 1-decene, 1-dodecene, 1-tetradecene, 1-hexadecene, 1-octadecene, 1-eicosene, and combinations thereof.

8. The (meth)acrylate-functionalized branched polyalpha-olefin of claim 1, wherein the at least one alpha-olefin monomer having at least six carbon atoms is a mixture of alpha-olefin monomers having chain lengths selected from the group consisting of C₁₀-C₁₃, C₂₀-C₂₄, C₂₄-C₂₈, and C₃₀ and higher chain lengths.

9. The (meth)acrylate-functionalized branched polyalpha-olefin of claim 1, wherein the (meth)acrylate-functionalized branched polyalpha-olefin has a number average molecular weight of from 500 to 10,000 daltons.

10. The (meth)acrylate-functionalized branched polyalpha-olefin of claim 1, wherein the (meth)acrylate source is selected from the group consisting of (meth)acrylic acid, (meth)acrylic anhydride, (meth)acryloyl halides, and C₁-C₄ esters of (meth)acrylic acid.

11. The (meth)acrylate-functionalized branched polyalpha-olefin of claim 1, wherein the (meth)acrylate-functionalized branched polyalpha-olefin contains from 1 to 8 (meth)acrylate functional groups per molecule.

12. The (meth)acrylate-functionalized branched polyalpha-olefin of claim 1, wherein at least 80% of the hydroxyl functional groups of the hydroxyl-functionalized branched polymerizate are converted to (meth)acrylate functional groups.

13. The (meth)acrylate-functionalized branched polyalpha-olefin of claim 1, wherein the hydroxyl-functionalized branched polymerizate has a hydroxyl equivalent weight of from 200 to 2000 grams per hydroxyl equivalent.

14. The (meth)acrylate-functionalized branched polyalpha-olefin of claim 1, wherein the hydroxyl-functionalized branched polymerizate has been obtained from an ester-functionalized branched polymerizate of, at least, i) one or more alpha-olefin monomers having at least six carbon atoms per molecule and ii) one or more unsaturated ester-functionalized comonomers, wherein one or more of the ester functional groups present in the ester-functionalized branched polymerizate have been converted to hydroxyl functional groups.

15. A method of preparing a (meth)acrylate-functionalized branched polyalpha-olefin, comprising reacting a (meth)acrylate source and a hydroxyl-functionalized branched polymerizate of, at least, i) at least one alpha-olefin monomer having at least six carbon atoms per molecule and ii) at least one unsaturated hydroxyl-functionalized comonomer, wherein one or more of the hydroxyl functional groups of the hydroxyl-functionalized branched polymerizate are converted to (meth)acrylate functional groups.

16. A (meth)acrylate-functionalized branched polyalpha-olefin comprised of a plurality of repeating units A in accordance with Formula (III) and a plurality of repeating units B in accordance with Formula (IV): 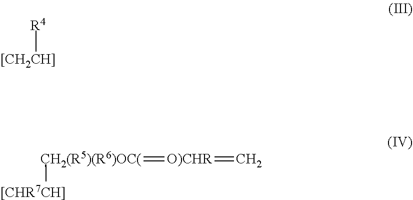
wherein R is H or methyl, R⁴ is an alkyl group comprised of at least four carbon atoms, R⁵ is a direct bond or a divalent alkylene group, R⁶ is optionally present, but if present, is a divalent oxyalkylene group or a divalent poly(oxyalkylene) group, and R⁷ is H or an alkyl group.

17. The (meth)acrylate-functionalized branched polyalpha-olefin of claim 16, wherein the (meth)acrylate-functionalized branched polyalpha-olefin is comprised of a plurality of repeating units A in accordance with Formula (Ma) and a plurality of repeating units B in accordance with Formula (IVb): 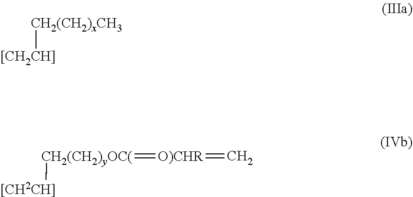
wherein x is an integer of at least 6, y is an integer of at least 0, and R is H or methyl.

18. The (meth)acrylate-functionalized branched polyalpha-olefin of claim 16, wherein the (meth)acrylate-functionalized branched polyalpha-olefin has a number average molecular weight of from 500 to 10,000 daltons.

19. The (meth)acrylate-functionalized branched polyalpha-olefin of claim 16, wherein the (meth)acrylate-functionalized branched polyalpha-olefin contains from 1 to 8 (meth)acrylate functional groups per molecule.

20. A curable composition comprised of a (meth)acrylate-functionalized branched polyalpha-olefin in accordance with claim 1 and at least one other (meth)acrylate-functionalized compound.

21. The curable composition of claim 20, wherein the curable composition is selected from the group consisting of adhesives, sealants, coatings, three dimensional printing and additive manufacturing resins, inks and molding resins.

22. A method of making an article, wherein the method comprises a step of exposing the curable composition of claim 20 to actinic radiation.

23. A crosslinkable resin composition comprised of a (meth)acrylate-functionalized branched polyalpha-olefin in accordance with claim 1 and at least one polymer.

24. A method of making an article, wherein the method comprises a step of crosslinking the crosslinkable resin composition of claim 23.
